(19) United States
(12) Patent Application Publication
(10) Pub. No.: US 2015/0269253 A1
(43) Pub. Date: Sep. 24, 2015

(54) INFORMATION PROCESSING DEVICE

(71) Applicant: NEC Corporation, Minato-ku, Tokyo (JP)

(72) Inventors: Junpei Kaminura, Tokyo (JP); Takehiko Kashiwagi, Tokyo (JP)

(73) Assignee: NEC Corporation, Minato-ku, Tokyo (JP)

(21) Appl. No.: 14/434,151

(22) PCT Filed: Sep. 24, 2013
(86) PCT No.: PCT/JP2013/005623

§ 371 Date: Apr. 8, 2015

(30) Foreign Application Priority Data
Oct. 11, 2012 (JP) 2012-226238

(51) Int. Cl. G06F 17/30

(52) U.S. Cl. CPC G06F 17/30705; G06F 17/30979

(57) ABSTRACT

This information processing device is provided with: data management means in which table-formatted data, with rows in which one group of tuple data units comprising a plurality of attribute data units are positioned and columns in which attributes are positioned, is stored so that the tuple data is collectively stored in a storage device by attribute data; and data processing means which executes predetermined processing with respect to a database. The data management means stores each attribute data unit that configures a tuple data unit in the order in which the tuple data units are positioned in the table format, in a plurality of chunks having storage areas of a predetermined capacity set for each of the attribute data units. Furthermore, the data management means acquires, for each attribute, deletion data information representing information specifying the table format order of the tuple data units that have attribute data units that have been deleted by the data processing means from the chunks that have been set for each attribute, and frees the chunks on the basis of the deletion data information.

### TECHNICAL FIELD

The present invention relates to an information processing apparatus and, more particularly, to an information processing apparatus which manages data on a column unit basis.

### BACKGROUND ART

In recent years, a technique of analyzing a large amount of data which changes with time such as position information in a real-time manner as much as possible is in demand. Consequently, a database is requested to have a high-speed query execution performance and, in addition, a high-speed data insertion, deletion, and updating performance.

For example, a technique regarding a database described below is known as a database having high IO (Input/Output) efficiency and capable of executing a query at high speed, in a database requested to have a high reading performance such as data analysis. That is, a technique of a column-store database which stores data divided by columns is known (refer to, for example, patent literature 1), as such a technique.

### CITATION LIST

### Patent Literature

[PTL 1] Japanese Unexamined Patent Application Publication No. 2012-123680

### SUMMARY OF INVENTION

### Technical Problem

To operate a system for long time, it is requested to release of a storage region which becomes unnecessary due to deletion of data, and to handle addition and deletion of a large amount of data. An example of a method of managing data in a column-store database will be described below.

First, referring to FIG. 1, data 1001 in a tabular form will be described. The data 1001 of FIG. 1 has two columns “a” and “b”. The data 1001 of FIG. 1 has 500 pieces of tuple data. To the data 1001 of FIG. 1, tuple identification data (TID) for uniquely specifying a tuple (row) is set for each tuple. TID is a natural number assigned sequentially from zero in order of physical arrangement of tuples.

Hereinafter, a management method using a paging method of allocating a new storage region (page) in the case where a new storage region becomes necessary for data storage and, deleting (releasing) the page when all of data in a page becomes unnecessary, will be described. In the case of storing tuple data by using the paging method, a column-store database obtains a plurality of storage regions (hereinbelow, described as chunks) having a predetermined size and manages them by columns (for example, the columns “a” and “b”). With reference to FIG. 2, an example of decomposing a tuple into columns and storing (saving) data will be described.

For example, the case, where the size of one piece of data in the column “a” is four bytes and size of chunk is, for example, set to fixed length of 400 bytes, will be described. In this case, as the entire storage capacity of data of the column “a”, 2000 bytes (=4 bytes×500 pieces) are necessary. Therefore, as illustrated in FIG. 2, the column-store database obtains five chunks Ca0 to Ca4 and manages them in the column “a”. Specifically, data of TID 0 to 99 (in the column “a”) is stored in the chunk Ca0. Data of TID 100 to 199 is stored in the chunk Ca1. Similarly, data of TID 200 to 299 is stored in the chunk Ca2. Data of TID 300 to 399 is stored in the chunk Ca3. Data of TID 400 to 499 is stored in the chunk Ca4.

For example, in the case where the size of one piece of data in the column “b” is two bytes, 1,000 bytes (=2 bytes×500 pieces) are necessary as an entire storage capacity of data of the column “b”. Therefore, as illustrated in FIG. 2, the column-store database obtains three chunks Cb0 to Cb2 and manages them. Specifically, data of TID 0 to 199 (in the column “b”) is stored in the chunk Cb0. Data of TID 200 to 399 is stored in the chunk Cb1. Similarly, data of TID 400 to 499 is stored in the chunk Cb2.

When all of the data included in a chunk is deleted in the case where the data is stored by columns as described above, the chunk may be released. When the chunk is released, the column-store database reuses the TID by moving up the TID of the chunks storing the data after the released chunk, by the number of data included in the released chunk.

However, in the case where the column-store database is constructed by a plurality of columns like the columns “a” and “b” as described above, when the number of pieces of data which can be stored in one chunk is different for the columns, a mismatch may occur in the TID for the columns. For example, when the data of the TID 100 to 199 is deleted, all of the data included in the second chunk Ca1 in the column “a” is deleted as illustrated in FIG. 3, so that, the chunk Ca1 is released. Then the column-store database moves up the TID included in the chunks Ca2 to Ca4 that stores the data after the chunk Ca1 which is released.

On the other hand, in the case of deleting the data of the TID 100 to 199, as illustrated in FIG. 3, only a part of the data included in the first chunk Cb0 in the column “b” is deleted, therefore the chunk Cb0 cannot be released, and the TID is not moved up. As a result, There is a problem that a mismatch occurs between the TID (tuple information) in the column “a” and the TID in the column “b”.

An object of the present invention is to provide an information processing apparatus capable of solving the problem that a mismatch in the tuple information occurs when a chunk is released.

### Solution to Problem

To achieve the object, an information processing apparatus as a mode of the present invention includes:

data managing means for storing data in a tabular form in which a group of tuple data including a plurality of pieces of attribute data is positioned in a row direction and the attributes are positioned in a column direction, into a storage apparatus, by putting together the tuple data for the each attribute data; and

data processing means for executing a predetermined process on the database,

wherein the data managing means stores attribute data constituting the tuple data, into a plurality of chunks each having a storage region of a predetermined capacity which is set for each of the attribute data in order that the tuple data is positioned in the tabular form, obtains, for the each attribute, deletion data information expressing information specifying the order in the tabular form of the tuple data including the attribute data deleted from the chunk which is set for the each attribute, by the data processing means, and releases the chunk on the basis of the deletion data information.

A program as another mode of the present invention is a program for making an information processing apparatus realize: data managing means for storing data in a tabular form in which a group of tuple data including a plurality of pieces of attribute data is positioned in a row direction and the attributes are positioned in a column direction, into a storage apparatus, by putting together the tuple data for the each attribute data; and

data processing means for executing a predetermined process on the database,

wherein the data managing means stores attribute data constituting the tuple data, into a plurality of chunks each having a storage region of a predetermined capacity which set for each of the attribute data in order that the tuple data is positioned in the tabular form, obtains, for the each attribute, deletion data information expressing information specifying the order in the tabular form of the tuple data including the attribute data deleted from the chunk which is set for the each attribute by the data processing means, and releases the chunk on the basis of the deletion data information.

An information processing method as another mode of the present invention includes the steps of, in an information processing apparatus,

when storing data in a tabular form in which a group of tuple data including a plurality of pieces of attribute data is positioned in a row direction and the attributes are positioned in a column direction, into a storage apparatus, by putting together the tuple data for the each attribute data, storing attribute data constituting the tuple data into a plurality of chunks each having a storage region of a predetermined capacity which is set for each of the attribute data in order that the tuple data is positioned in the tabular form,

obtaining, for the each attribute, deletion data information expressing information specifying the order in the tabular form of the tuple data including the attribute data deleted from the chunk which is set for the each attribute, and releasing the chunk on the basis of the deletion data information.

### Advantageous Effects of Invention

With the above configuration, the present invention has an excellent effect that when a chunk is released, consistency of data by columns may be maintained.

### BRIEF DESCRIPTION OF DRAWINGS

FIG. 1 is a diagram for explaining an example of a database.

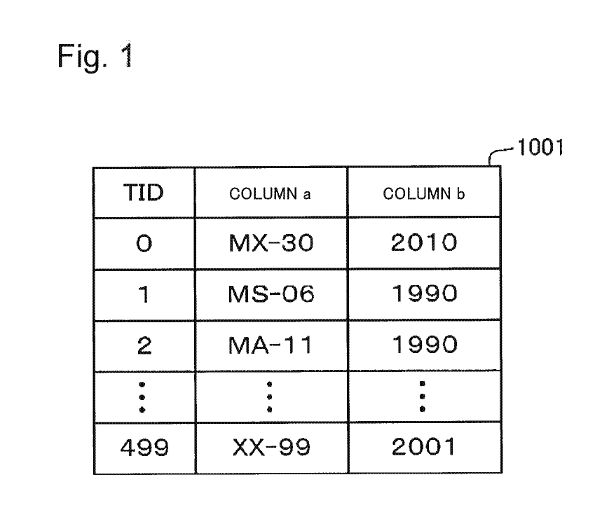

FIG. 2 is a diagram for explaining an example of storing data by columns.

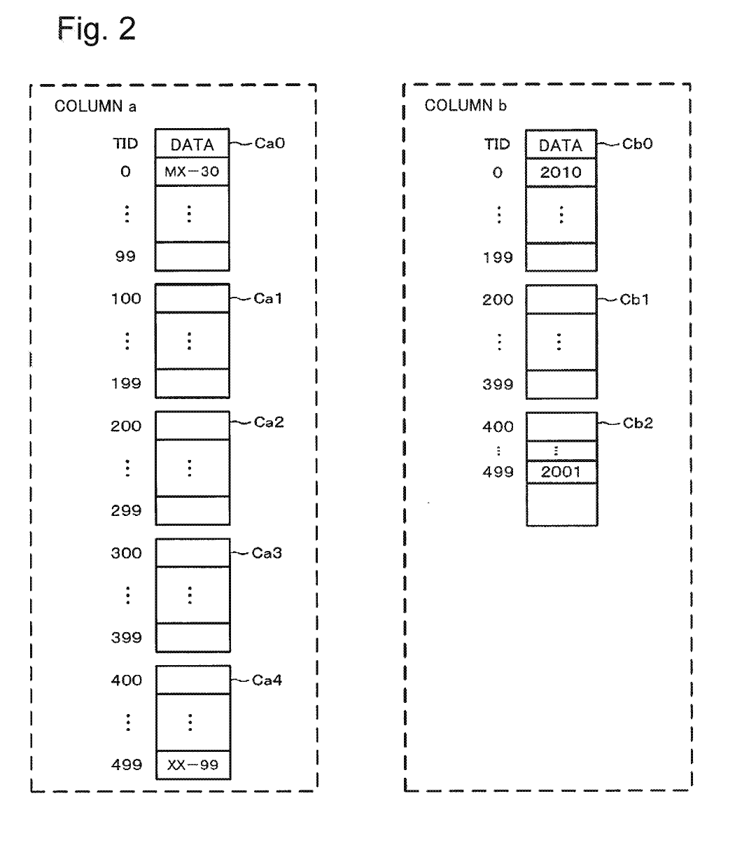

FIG. 3 is a diagram for explaining an example of releasing stored data.

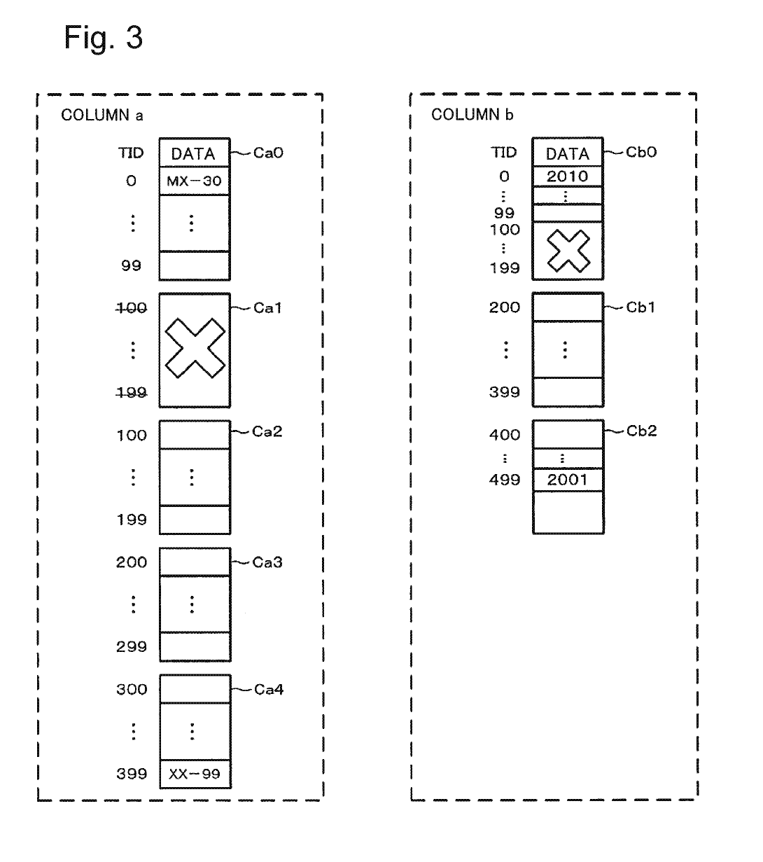

FIG. 4 is a block diagram illustrating outline of the configuration of an information processing apparatus in the present invention.

FIG. 5 is a functional block diagram illustrating the configuration of an processing unit in the information processing apparatus in the present invention.

FIG. 6 is a diagram for explaining an example of a database.

FIG. 7 is a diagram for explaining an example of a storage unit.

FIG. 8 is a diagram for explaining an example of a storage unit.

FIG. 9 is a diagram for explaining an example of a storage unit.

FIG. 10 is a diagram for explaining an example of an offset management table.

FIG. 11 is a diagram for explaining an example of a storage unit.

FIG. 12 is a diagram for explaining an example of a storage unit.

FIG. 13 is a diagram for explaining outline of data stored in the offset management table.

FIG. 14 is a diagram for explaining outline of data stored in the offset management table.

FIG. 15 is a flowchart for explaining a data deleting process.

FIG. 16 is a flowchart for explaining a data retrieving process.

FIG. 17 is a flowchart for explaining a data obtaining process.

FIG. 18 is a block diagram illustrating outline of the configuration of an information processing apparatus in the present invention.

FIG. 19 is a diagram illustrating an example of updating of a category management table.

FIG. 20 is a diagram for explaining an example of a storage unit.

FIG. 21 is a diagram for explaining an example of a storage unit.

FIG. 22 is a diagram for explaining an example of an offset management table.

FIG. 23 is a diagram for explaining an example of an offset management table.

FIG. 24 is a diagram for explaining an example of a storage unit.

FIG. 25 is a block diagram illustrating outline of the configuration of an information processing apparatus in the present invention.

FIG. 26 is a functional block diagram illustrating the configuration of an processing unit in the information processing apparatus in the present invention.

FIG. 27 is a diagram for explaining an example of a storage unit.

FIG. 28 is a diagram for explaining an example of a storage unit.

### DESCRIPTION OF EMBODIMENTS

### First Exemplary Embodiment

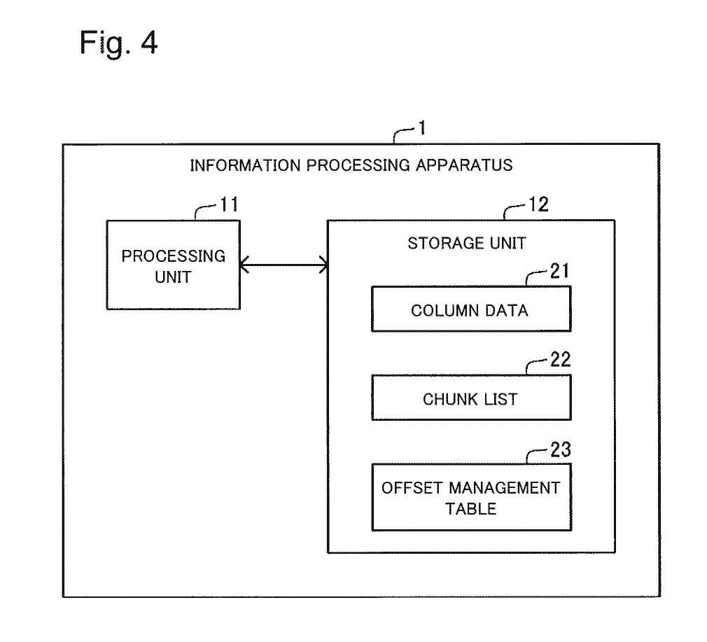

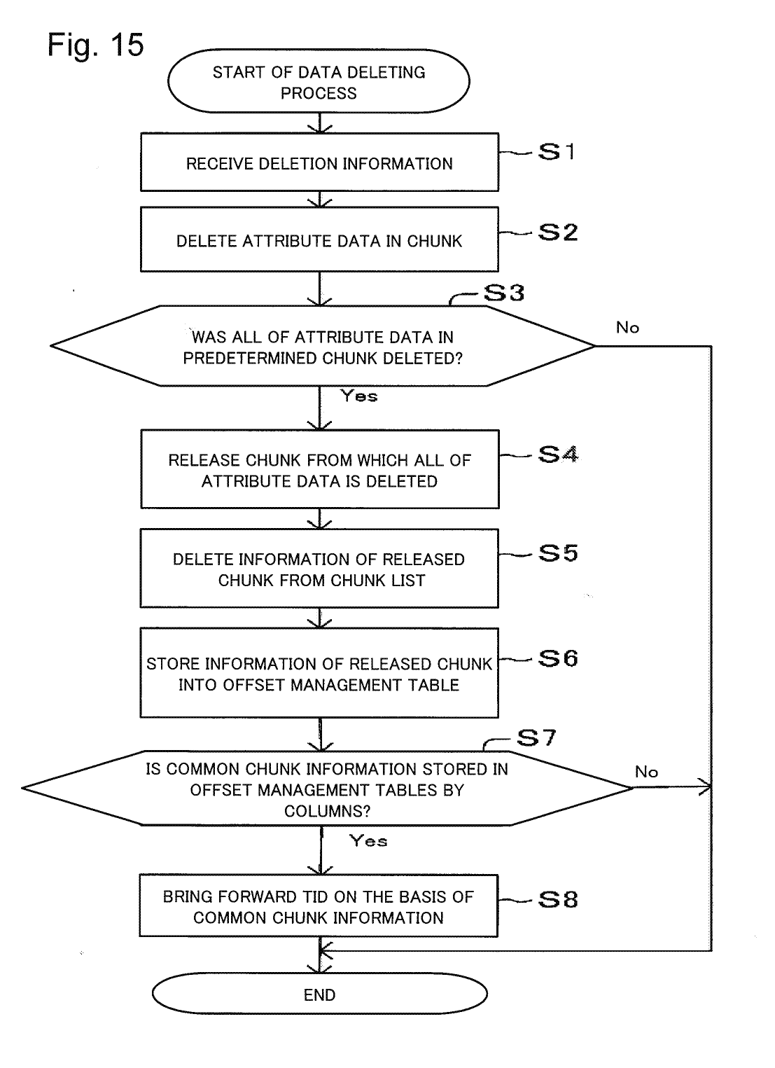

A first exemplary embodiment of the present invention will be described with reference to FIGS. 4 to 17. FIGS. 4 to 14 are diagrams for explaining the configuration of an information processing apparatus. FIGS. 15 to 17 are diagrams for explaining the operation of the information processing apparatus.

(Configuration)

First, with reference to FIG. 4, an information processing apparatus 1 storing and processing data in a tabular form on a column unit basis will be described. FIG. 4 is a block diagram illustrating a configuration example of the information processing apparatus 1 in the exemplary embodiment. As illustrated in FIG. 4, the information processing apparatus 1 has an processing unit 11 and a storage unit 12.

The storage unit 12 has, for example, a hard disk drive, a nonvolatile memory, a volatile memory, an SSD (Solid State Drive), and the like. The storage unit 12 stores column data 21, a chunk list 22, and an offset management table 23. The column data 21 is data obtained by putting together tuple data, in a database, on the column unit basis. The details of the column data 21, the chunk list 22, and the offset management table 23 will be described later.

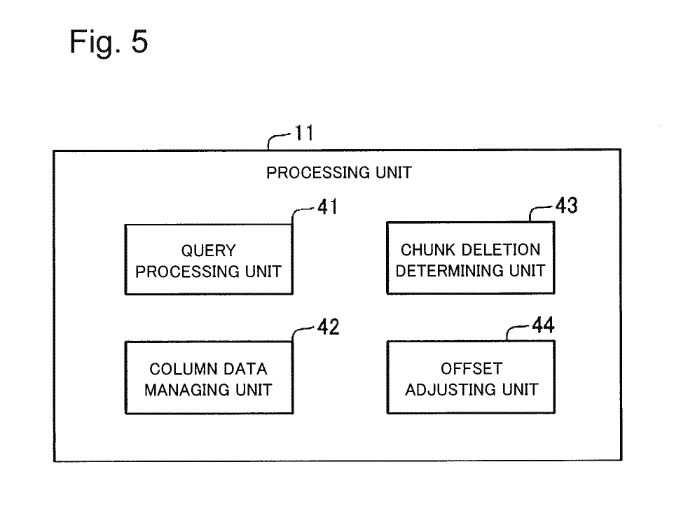

The processing unit 11 is configured with a CPU (Central Processing Unit), for example. The processing unit 11 reads a program stored in a ROM (Read Only Memory) included in the storage unit 12 and executes the program using a RAM (Random Access Memory) include in the storage unit 12 as a work area. In such a manner, the processing unit 11 executes various functions for controlling the information processing apparatus 1. FIG. 5 is a block diagram illustrating a functional configuration example of the processing unit 11. The processing unit 11 in FIG. 5 includes the following functional blocks by executing a program. In other words, the processing unit 11 includes functional blocks of a query processing unit 41 (data processing means), a column data managing unit 42 (data managing means), a chunk deletion determining unit 43 (data managing means), and an offset adjusting unit 44 (data managing means).

The query processing unit 41 executes a predetermined process on data in a tabular form (for example, a database) in accordance with a processing request (query) from the user. The query is, for example, in the SQL (Structured Query Language) or the like. The column data managing unit 42 arranges attribute data of tuple data constructing the data in the tabular form by each column (attribute) and stores it as the column data 21 in the storage unit 12. The column data managing unit 42 extracts predetermined attribute data in accordance with a process of the query processing unit 41 and outputs it.

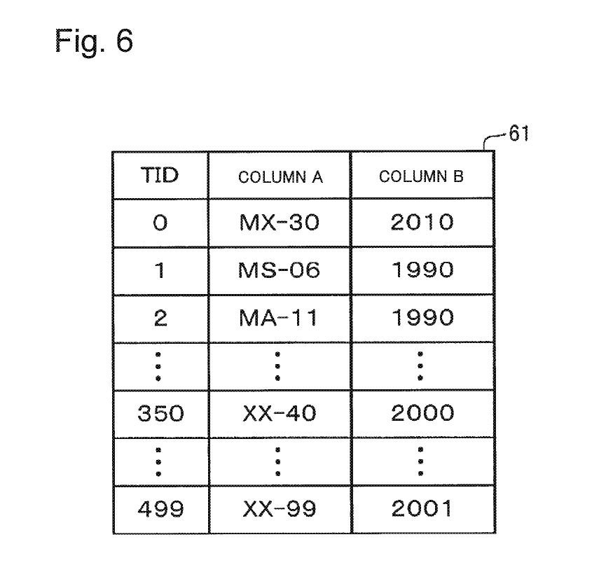

With reference to FIG. 6, the data in the tabular form will be described. Data 61 of FIG. 6 has two columns A and B. The data 61 in FIG. 6 has 500 pieces of tuple data. In the data 61 of FIG. 6, tuple identification data (TID) is set for uniquely specifying a tuple (row) in the data 61. TID is a natural number assigned sequentially from zero in the order of physical arrangement of the tuple data. In the data 61 of FIG. 6, TID is assigned from 0 to 499.

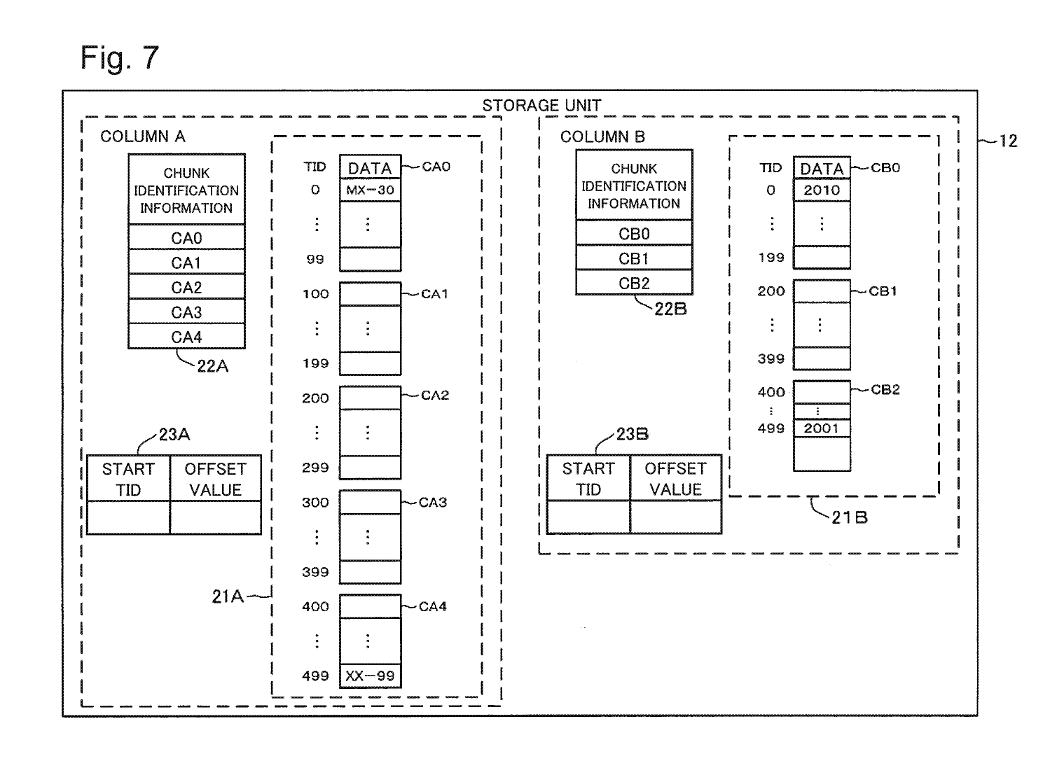

The column data managing unit 42 stores, for example, the data 61 in the tabular form illustrated in FIG. 6, in which a group of tuple data consisting of attribute data of a plurality of columns (attributes) is positioned in the row direction, and the columns are positioned in the column direction as follows. That is, the column data managing unit 42 stores the data 61 in the tabular form, so that the each attribute data of the tuple data is put together for each column (attribute), in the column data 21 in the storage unit 12. FIG. 7 is a diagram illustrating an example of the storage unit 12. As illustrated in FIG. 7, the column data managing unit 42 stores the attribute data constituting the tuple data in a plurality of chunks each having a storage region of predetermined capacity which are set for the each attribute data (for example, attribute data in the column A and the attribute data in the column B). The column data managing unit 42 stores the attribute data constituting the tuple data in the chunks in the column data 21, in order that the tuple data is positioned in the tabular form.

For example, it is assumed that the chunk size is a fixed length of 400 bytes and the size of one piece of attribute data in the column A is four bytes. In this case, the entire storage capacity (space) of the attribute data in the column A is 2,000 (4 bytes×500 pieces) bytes. One hundred pieces of attribute data can be stored in one chuck. As illustrated in FIG. 7, the column data managing unit 42 obtains five chunks CA0 to CA4 and sequentially stores the attribute data in the column A of the data 61. The TID in the column data 21 in FIG. 7 is illustrated for explanation, and is not stored in the actual column data 21.

The column data managing unit 42 stores, in the chunk list 22, pointer information such as an address or identification information by which each of the plurality of chunks stored in the column data 21 can be specified. For example, the column data managing unit 42 stores the head address of each of the chunks CA0 to CA4 into the chunk list 22. In the following, the case where the identification information of the chunks is stored in the chunk list 22 will be described. Specifically, the column data managing unit 42 stores the chunk identification information CA0 to CA4 in a chunk list 22A of the column A.

On the other hand, it is assumed that the size of one piece of attribute data in the column B is two bytes, for example. In this case, the entire storage capacity of the attribute data in the column B is 1,000 (2 bytes×500 pieces) bytes. Two hundred pieces of attribute data can be stored in one chuck. As illustrated in FIG. 7, the column data managing unit 42 obtains three chunks CB0 to CB2 and sequentially stores the attribute data in the column B of the data 61. The column data managing unit 42 stores the chunk identification information CB0 to CB2 in a chunk list 22B of the column B.

In the case where the query processing unit 41 executes predetermined processes (a data deleting process, a data retrieving (searching) process, and a data obtaining process which will be described later) on the data 61, the column data managing unit 42 reads the attribute data stored by columns. Accordingly, the column data managing unit 42 can extract the attribute data of a predetermined column requested by the query processing unit 41 more promptly.

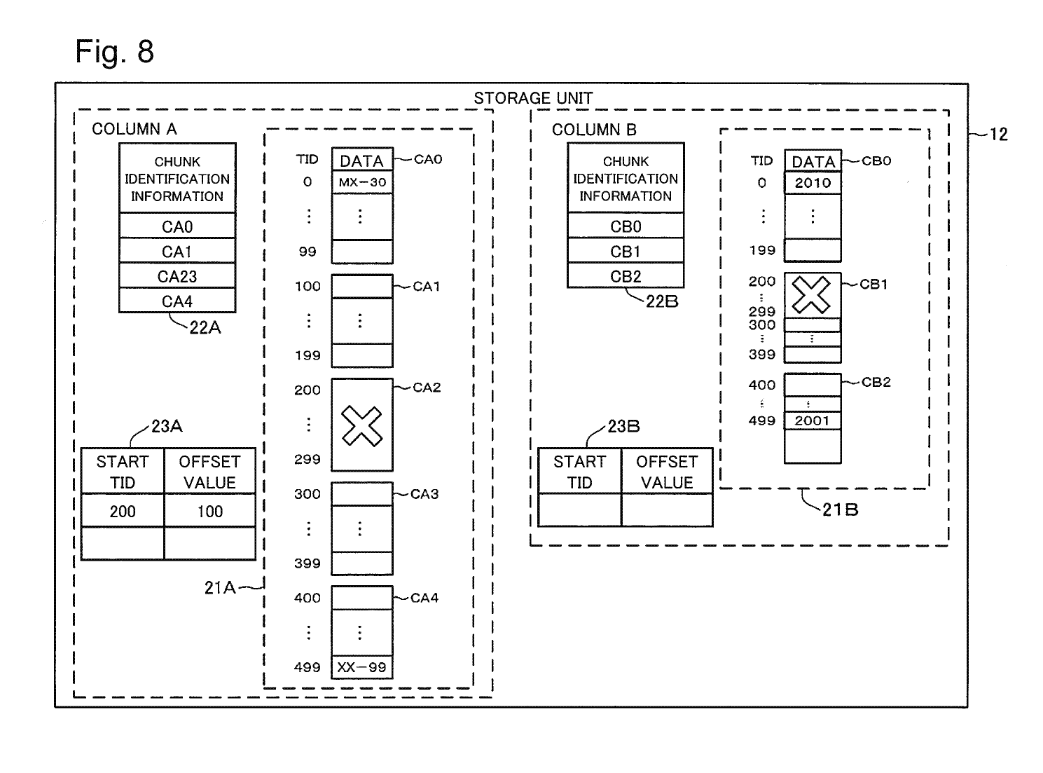

Next, the data deleting process, the data retrieving process, and the data obtaining process executed on the data 61 by the query processing unit 41 will be described. Referring to FIG. 8, the data deleting process will be described first. In the following, the case where the query processing unit 41 receives a request of deleting 100 pieces of tuple data of TID 200 to 299 from the user via an input apparatus (not illustrated) will be described. In this case, the query processing unit 41 deletes the tuple data of TID 200 to 299 in the data 61. More specifically, the query processing unit 41 deletes the attribute data of TID 200 to 299 stored in the column data 21A and 21B from the chunks. For example, the query processing unit 41 deletes the attribute data stored in the chunk CA2 and also deletes the attribute data stored in the chunk CB1.

The chunk deletion determining unit 43 determines whether a chunk can be deleted by the data deleting process of the query processing unit 41 or not. More specifically, the chunk deletion determining unit 43 obtains, for the each column, deletion data information that expresses information (TID) specifying the order of the attribute data, deleted from the chunks, in the tabular form of the tuple data. The attribute data deleted from the chunks set for the each column, by the query processing unit 41 are included in the tabular from of the tuple data. For example, in the case where the attribute data of TID 200 to 299 is deleted by the query processing unit 41 in the column A, the chunk deletion determining unit 43 obtains the TID 200 to 299 as deletion data information. In this case, the chunk deletion determining unit 43 determines that all of the attribute data stored in the chunk CA2 is deleted on the basis of the obtained deletion data information. Therefore, the chunk deletion determining unit 43 determines that the chunk CA2 can be deleted and releases the chunk CA2 in the column data 21.

The chunk deletion determining unit 43 deletes the chunk identification information “CA2” stored in the chunk list 22A of the column A and updates the chunk list 22A (stores the deletion data information). When the chunk CA2 is released by the chunk deletion determining unit 43, the column data managing unit 42 stores start TID (start data information) “200” (deletion data information) as TID of the first attribute data stored in the chunk CA2 into an offset management table 23A. The column data managing unit 42 also stores an offset value (the number of pieces of attribute data) “100” (deletion data information) as the number of pieces of attribute data stored in the chunk CA2 into the offset management table 23A.

On the other hand, in the case where the attribute data of TID 200 to 299 is deleted by the query processing unit 41 in the column B, a part of the attribute data stored in the chunk CB1 is deleted. However, attribute data of TID 300 to 399 is still stored in the chunk CB1. Therefore, the chunk deletion determining unit 43 determines that the chunk CB1 cannot be deleted and does not release the chunk CB1.

Next, the process in the case, where the query processing unit 41 performs the data retrieving process after performing the data deleting process of the attribute data of TID 200 to 299, will be described. In this example, a process in the case of retrieving TID (tuple) whose attribute data in the column A is “XX-40” and whose attribute data in the column B is “2000”, from the data 61 of FIG. 6, will be described.

The query processing unit 41 refers to the chunk list 22A of the column A of FIG. 8 and extracts chunks in order of CA0, CA1, CA3, and CA4. Then the query processing unit 41 performs a matching process. More specifically, the query processing unit 41 performs a process of determining whether attribute data in the extracted chunks matches “XX-40” or not. For example, the query processing unit 41 determines whether the attribute data having TID “0” in the extracted chunk CA0 matches “XX-40” or not. Subsequently, the query processing unit 41 increments the value of TID by one each time the attribute data in the chunk is extracted and determines whether the attribute data corresponding to the TID incremented by one matches “XX-40” or not.

When the value of the TID and the value of the start TID stored in the offset management table 23A are to match by incrementing the value of the TID by one, the query processing unit 41 adds an offset value to the value of the TID. For example, when the value of the TID is incremented by one and the value of the TID becomes “200”, the query processing unit 41 determines the value matches the start TID “200” stored in the offset management table 23A. In this case, the query processing unit 41 adds an offset value “100” to the TID value “200” and obtains a new TID value “300”. Then, the query processing unit 41 determines whether the attribute data of TID “300” matches “XX-40” or not. After that, the query processing unit 41 repeats the above-described data retrieving process. As a result, the query processing unit 41 can retrieve, for example, TID “350” in which the attribute data “XX-40” is stored.

In such a manner, the query processing unit 41 executes the data retrieving process on the chunk CA3 in which attribute data is stored after the chunk CA2 without referring to the attribute data in the deleted chunk CA2. The query processing unit 41 can execute the data retrieving process of attribute data of TID 0 to 499 stored in the column data 21A virtually, regardless of the fact that the chunk CA2 is deleted.

The query processing unit 41 refers to the chunk list 22B of the column B and extracts chunks in order of CB0, CB1, and CB2. The query processing unit 41 determines whether attribute data in the extracted chunks matches “2000” or not. For example, the query processing unit 41 determines whether the attribute data having TID “0” in the extracted chunk CB0 matches “2000” or not. Subsequently, the query processing unit 41 increments the value of TID by one each time the attribute data in the chunk is extracted and determines whether the attribute data corresponding to the TID incremented by one matches “2000” or not.

Since the start TID and an offset value are not stored in an offset management table 23B of the column B, the query processing unit 41 executes the data retrieving process in order on attribute data of TID 0 to 499.

In such a manner, even in the case where one chunk in the column A is released, without causing a mismatch between the TID in the column A and the TID in the column B, the query processing unit 41 can reliably execute the data retrieving process.

Next, processes in the case where the query processing unit 41 performs a data obtaining process after performing the data deleting process of the attribute data of TID 200 to 299 will be described below. In this example, processes for the case of obtaining attribute data corresponding to TID “350” as an acquisition target from the data 61 in FIG. 6, will be described.

The query processing unit 41 refers to the chunk list 22A in the column A and extracts chunks in order of CA0, CA1, CA3, and CA4. The query processing unit 41 adds the number of pieces of attribute data in the extracted chunks to TID (initial value: zero). Subsequently, the query processing unit 41 determines whether the added TID value exceeds “350” or not. For example, the query processing unit 41 determines whether the number of pieces of attribute data 100 (=TID) in the extracted chunk CA0 exceeds “350” or not. When the query processing unit 41 determines that the TID=100 does not exceed “350”, the query processing unit 41 extracts the chunk CA1 and adds the number of pieces of attribute data, that is 100, in the chunk CA1 to TID (=100). That is, the query processing unit 41 calculates as TID=200.

At this time, the query processing unit 41 determines that the value of TID (=200) and the value of the start TID stored in the offset management table 23A are to match, so that the offset value “100” is added to the value of TID. That is, the query processing unit 41 calculates as TID=300. In the same way, the query processing unit 41 determines that the TID=300 does not exceed “350”. Then, the query processing unit 41 extracts the next chunk CA3, and adds the number of pieces of attribute data 100 in the chunk CA3 to TID (=300). That is, the query processing unit 41 calculates as TID=400. At this time, the query processing unit 41 determines that TID=400 exceeds “350”. It is consequently clarified that the attribute data corresponding to TID “350” is stored in the chunk CA3, before the number of pieces of attribute data in the chunk CA3 is added. Therefore, the query processing unit 41 obtains attribute data corresponding to TID “350” from the chunk CA3. For example, the attribute data “XX-40” corresponding to TID “350” can be obtained. As described above, although the chunk CA2 is deleted, the query processing unit 41 can execute a data obtaining process of obtaining attribute data corresponding to TID “350”.

The query processing unit 41 refers to the chunk list 22B in the column B and extracts the chunks in order of CB0, CB1, and CB2. The query processing unit 41 adds the number of pieces of attribute data in the extracted chunks to TID (initial value: zero). The query processing unit 41 determines whether the value of TID after the addition exceeds “350” or not. In the column B, when the query processing unit 41 extracts the chunk CB1, TID becomes 400 and the query processing unit 41 determines that TID=400 exceeds “350”. Therefore, the query processing unit 41 obtains attribute data corresponding to TID “350” from the chunk CB1. For example, the attribute data “2000” corresponding to TID “350” can be obtained.

As described above, also in the case where one chunk in the column A is released, without causing a mismatch between the TID in the column A and the TID in the column B, the query processing unit 41 can reliably execute the data obtaining process.

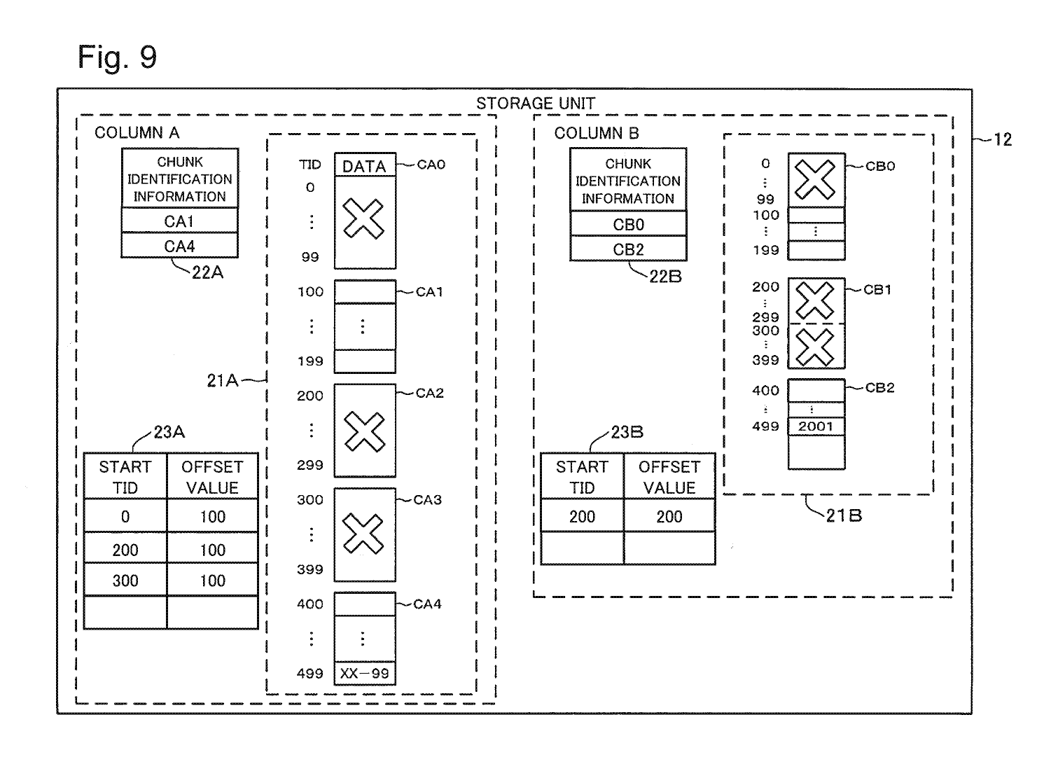

Next, with reference to FIG. 9, a case will be described in which after performing a data deleting process on attribute data of TID 200 to 299, the query processing unit 41 further receives a request of deleting 100 pieces of tuple data corresponding to TID 0 to 99 and 100 pieces of tuple data corresponding to TID 300 to 399 from the user via an input apparatus (not illustrated). In this case, the query processing unit 41 deletes the tuple data of TID 0 to 99 and the tuple data of TID 300 to 399. More specifically, the query processing unit 41 deletes each of the attribute data of TID 0 to 99 and each of the attribute data of TID 300 to 399, stored in the each column of the column data 21.

The chunk deletion determining unit 43 determines whether or not a chunk can be deleted by the data deleting process of the query processing unit 41. In the case where the attribute data of TID 0 to 99 is deleted by the query processing unit 41 in the column A, all of the attribute data stored in the chunk CA0 is deleted. Therefore, the chunk deletion determining unit 43 determines that the chunk CA0 can be deleted and releases the chunk CA0 in the column data 21. Similarly, in the case where the attribute data of TID 300 to 399 is deleted by the query processing unit 41 in the column A, all of the attribute data stored in the chunk CA3 is deleted. Therefore, the chunk deletion determining unit 43 determines that the chunk CA3 can be deleted and releases the chunk CA3 in the column data 21.

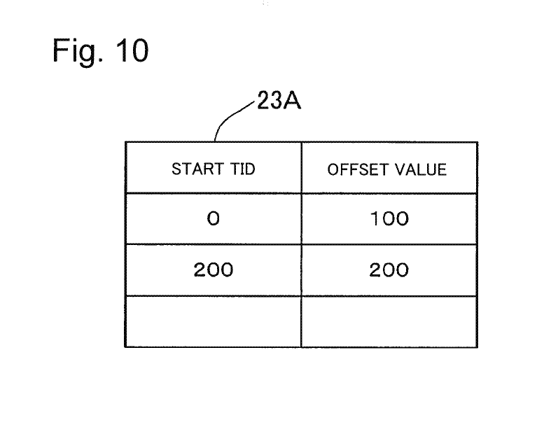

Further, the chunk deletion determining unit 43 deletes chunk identification information “CA0” and CA3” stored in the chunk list 22A of the column A. When the chunks CA0 and CA3 are released by the chunk deletion determining unit 43, the column data managing unit 42 stores the start TID “0” of the chunk CA0 and the start TID “300” of the chunk CA3 into the offset management table 23A. The data managing unit 42 also stores the offset value “100” as the number of pieces of attribute data stored in the chunks CA0 and CA3 into the offset management table 23A. Note that the information of the start TID “200” and the offset value “100” indicates deletion of the attribute data of TID 200 to 299. Consequently, in the case where the attribute data of TID 300 to 399 is deleted by the query processing unit 41, the attribute data of TID 200 to 399 is deleted. Therefore, as illustrated in FIG. 10, the column data managing unit 42 can store the start TID “200” and the offset value “200” into the offset management table 23A.

On the other hand, in the case where the attribute data of TID 0 to 99 is deleted by the query processing unit 41 in the column B, a part of the attribute data stored in the chunk CB0 is deleted, but the attribute data is still stored in the chunk CB0. Therefore, the chunk deletion determining unit 43 determines that the chunk CB0 cannot be deleted, and does not release the chunk CB0. In the case where the attribute data of TID 300 to 399 is deleted by the query processing unit 41 in the column B, all of the attribute data stored in the chunk CB1 is deleted. Therefore, the chunk deletion determining unit 43 determines that the chunk CB1 can be deleted and releases the chunk CB1 in the column data 21. The chunk deletion determining unit 43 deletes the chunk identification information “CB1” stored in the chunk list 22B in the column B. Subsequently, when the chunk CB1 is released by the chunk deletion determining unit 43, the column data managing unit 42 stores the start TID “200” of the chunk CB1 into the offset management table 23B. The column data managing unit 42 also stores the offset value “200” as the number of pieces of attribute data stored in the chunk CB1 into the offset management table 23B.

When the data deleting process is executed as described above, there is a case where the information stored in the offset management table 23A and the information stored in the offset management table 23B in FIG. 9 match. Hereinafter a process of optimizing (adjusting) the offset management table 23 will be described. The offset adjusting unit 44 may execute the process of optimizing the offset management table 23 at arbitrary timing. For example, the offset adjusting unit 44 optimizes the offset management table 23, in the case where after preset time elapses, or in the case where preset number of pieces of attribute data stored in the chunks of the column data 21 is deleted. The offset adjusting unit 44 refers to the offset management table 23A in FIG. 9 (or FIG. 10) and the offset management table 23B in FIG. 9 and determines whether there is a common TID range (deletion data information) or not.

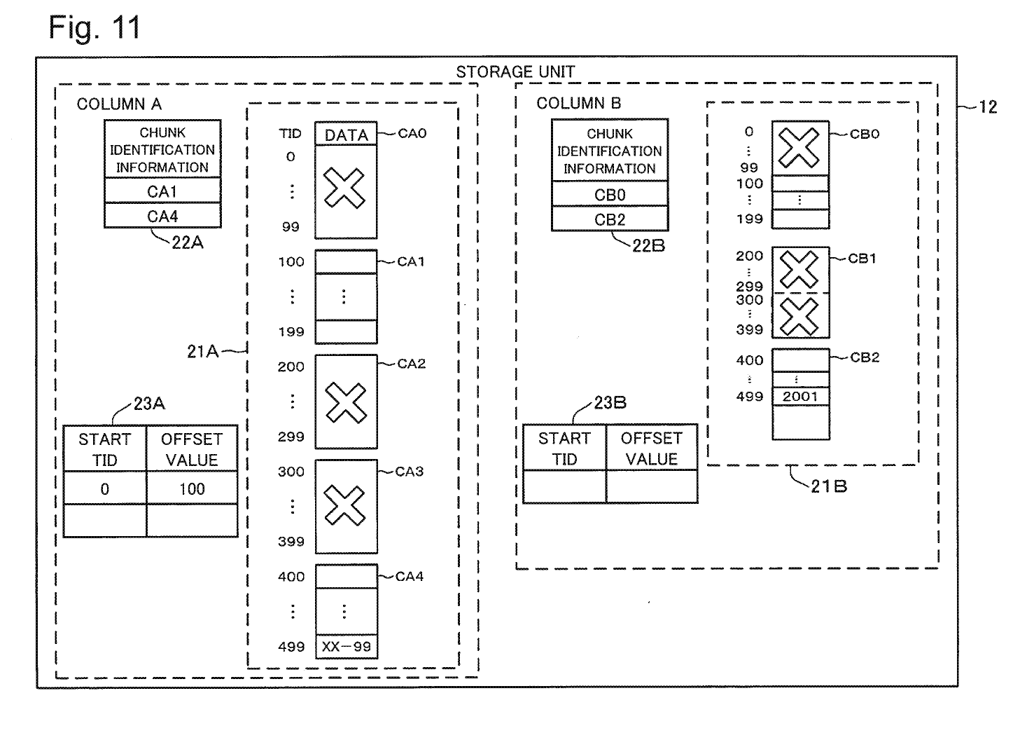

In the examples of FIGS. 9 and 10, the start TID “200” and the offset value “200” match (are common) in the columns A and B. Consequently, when the offset adjusting unit 44 deletes the common information of the start TID “200” and the offset value “200”, a mismatch of TID does not occur when a predetermined process is executed by the query processing unit 41. Therefore, as illustrated in FIG. 11, the offset adjusting unit 44 deletes the start TID “200” and the offset value “200” stored in the offset management tables 23A and 23B. In such a manner, the offset adjusting unit 44 can delete redundant information and reduce the storage capacity (size) of the offset management table 23.

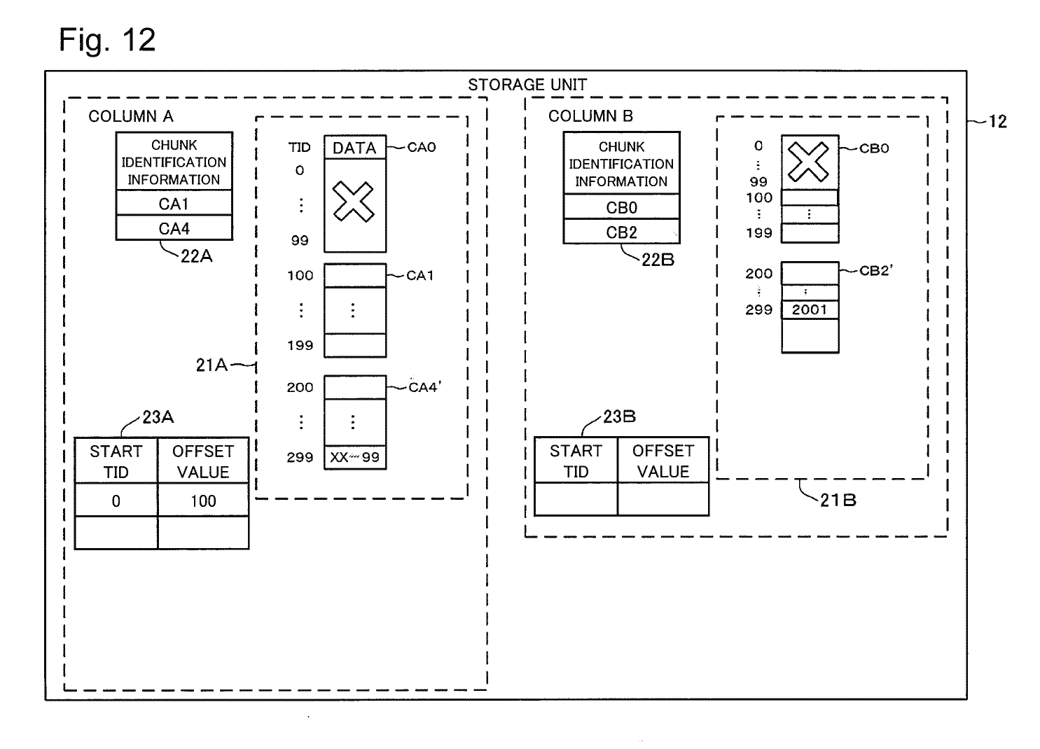

The column data managing unit 42 refers to the the offset management table 23, and when there is a common TID range in the table, the column data managing unit 42 deletes the TID range. By that, the column data managing unit 42 can advance the value of TID (the value is the order in the tabular form of the attribute data), in a chunk storing attribute data after the released chunk, corresponding to the common TID range (deletion data information). More specifically, when the common TID range is TID 200 to 399 (FIG. 9), the offset adjusting unit 44 deletes the attribute data in the common TID range from the offset management table 23 (FIG. 11). The offset adjusting unit 44 adjusts (advances) the range (value) of the TID of the attribute data stored in the offset management table 23 subsequent to the deleted attribute data. When the query processing unit 41 reads the attribute data by columns (for example, in the data retrieving process or the data obtaining process), the column data managing unit 42 advances the values of TID 400 to 499 (the value is the order in the tabular form of the attribute data), by 200 (the number of pieces of attribute data). The attribute data of TID 400 to 499 are in the chunk (for example, chunk CA4) storing the attribute data after the released chunk (for example, the chunks CA2 and CA3), corresponding to the common TID. And then, the column data managing unit 42 obtains attribute data of TID 200 to 299 (refer to, for example, FIG. 12). The column data managing unit 42 outputs the obtained attribute data to the query processing unit 41. In such a manner, the value of TID can be maintained as a small value, and digit overflow of the value of TID can be prevented. Therefore, long term operation of the database can be realized.

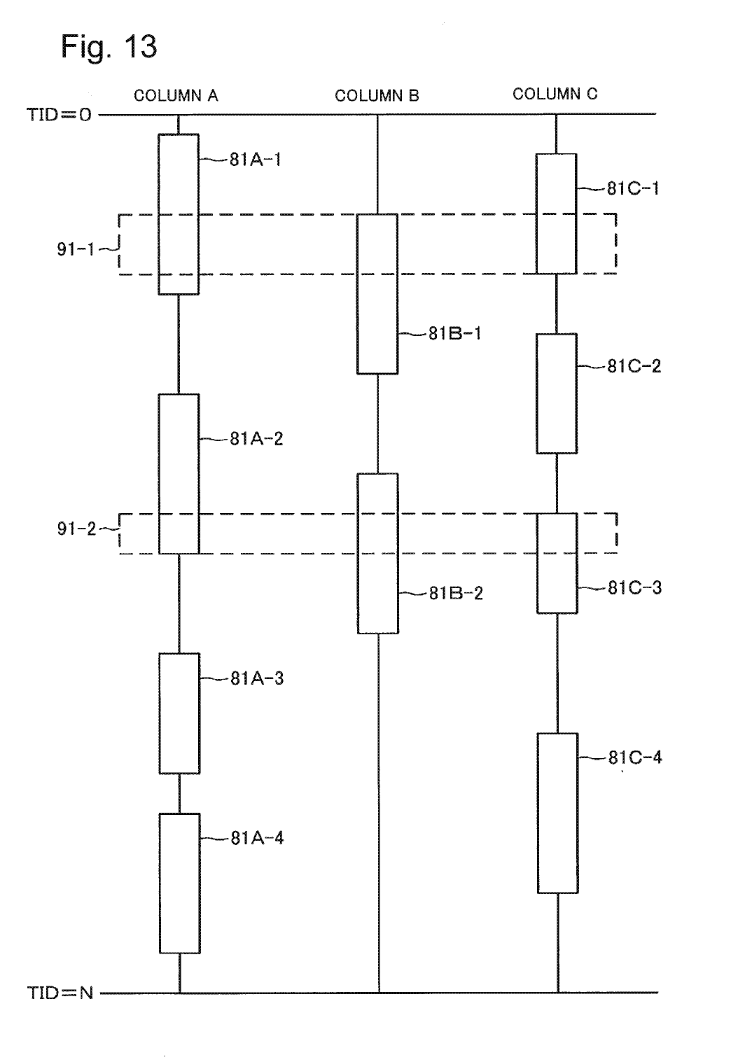

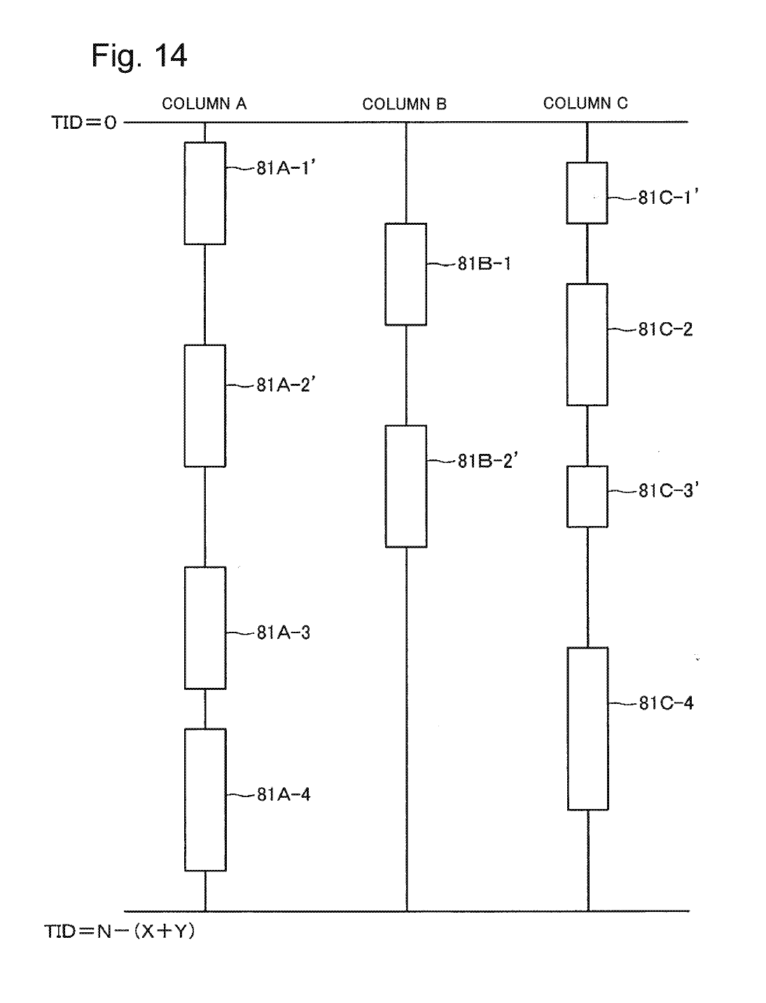

Referring to FIGS. 13 and 14, outline of an offset adjusting process on a database including three columns (columns A, B, and C) will be described. FIG. 13 is an visualized diagram illustrating deletion data information stored in the offset management table 23. It is assumed that, in the example of FIG. 13, some of given tuple data is deleted from a database including (N+1) pieces of tuple data of TID 0 to N (N is a natural number), and release of a chunk for the each column is performed a few times. In the example of FIG. 13, in the offset management table 23, TID ranges 81A-1 to 81A-4 of four released chunks in the column A are stored. In the offset management table 23, TID ranges 81B-1 to 81B-2 of two released chunks in the column B are stored. In the offset management table 23, TID ranges 81C-1 to 81C-4 of four released chunks in the column C are also stored.

The offset adjusting unit 44 detects common deletion data information in the TID ranges (deletion data information) of these released chunks. The offset adjusting unit 44 advances the TID of the chunks storing attribute data subsequent to a released chunk corresponding to the detected deletion data information. Specifically, the offset adjusting unit 44 performs a process of cutting a common TID range among the TID ranges 81A-1 to 81A-4, the TID ranges 81B-1 to 81B-2, and the TID ranges 81C-1 to 81C-4.

In the example of FIG. 13, the TID ranges indicated by common deletion data information 91-1 and 91-2 are common TID ranges which can be deleted. It is assumed that the number of pieces of attribute data included in the common deletion data information 91-1 is X (X is a natural number, X<N), and the number of pieces of attribute data included in the common deletion data information 91-2 is Y (Y is a natural number, Y<N). In this case, FIG. 14 illustrates a result of deleting each of the common deletion data information 91-1 and 91-2 and advancing the TID by the offset adjusting unit 44.

FIG. 14 is an visualized diagram illustrating deletion data information stored in the offset management table 23 after performing the offset adjusting process. As illustrated in FIG. 14, the offset adjusting unit 44 truncated TID ranges by deleting the TID ranges indicated by the common deletion data information 91-1 and 91-2 in FIG. 13 and bringing (advancing) the TID forward. By the operation, the maximum value of TID decreases from N to (N−(X+Y)). More specifically, by deleting the common deletion data information by the offset adjusting unit 44, TID ranges 81A-1′, 81A-2′, 81A-3, and 81A-4 of chunks which are released in the column A, are stored in the offset management table 23. In the offset management table 23, TID ranges 81B-1′ and 81B-2′ of chunks which are released in the column B, are stored. Further, in the offset management table 23, TID ranges 81C-1′, 81A-2, 81A-3′, and 81A-4 of chunks released in the column C are stored.

Also in the case of executing the offset adjusting process on a database including three columns, digit overflow of the TID value can be prevented. As a result, the database can be operable for long time. Obviously, the number of columns is not limited to three but may be four or more plural number. As illustrated in FIGS. 13 and 14, in the case where common deletion data information (TID range) exists while the start TIDs and the offsets stored in the each offset management table 23 for each column do not match, the offset adjusting unit 44 deletes the information of a released chunk corresponding to the common deletion data information. And then the offset adjusting unit 44 can advance TID of a chunk storing the attribute data after the chunk.

(Operation)

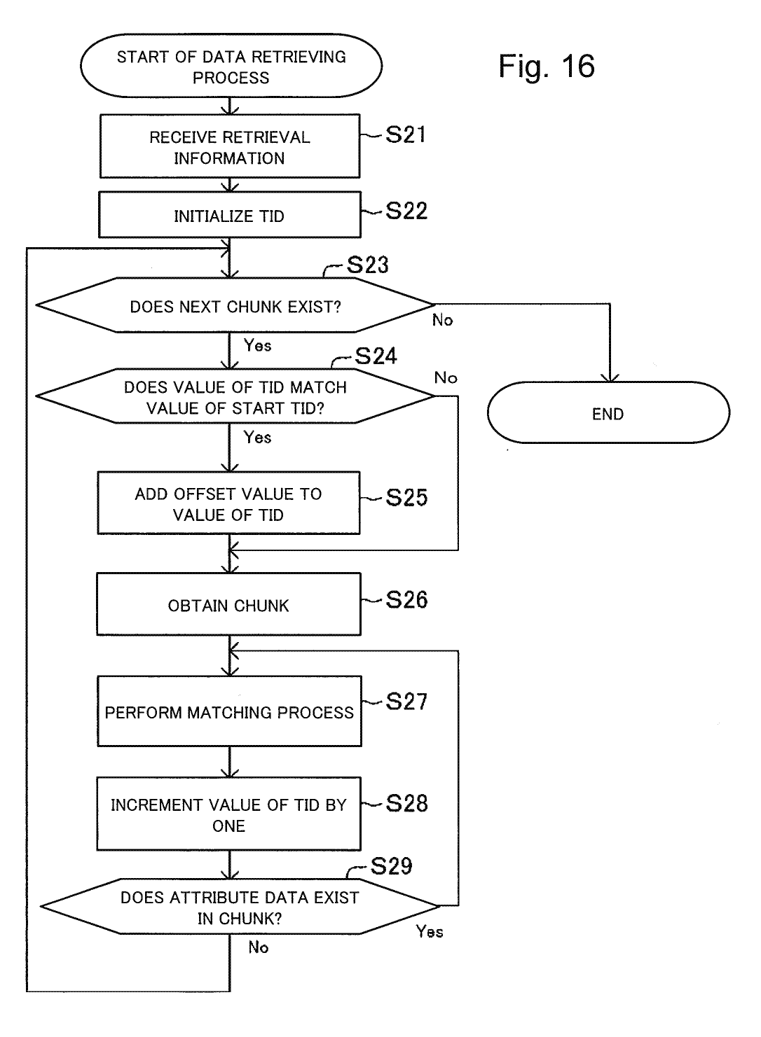

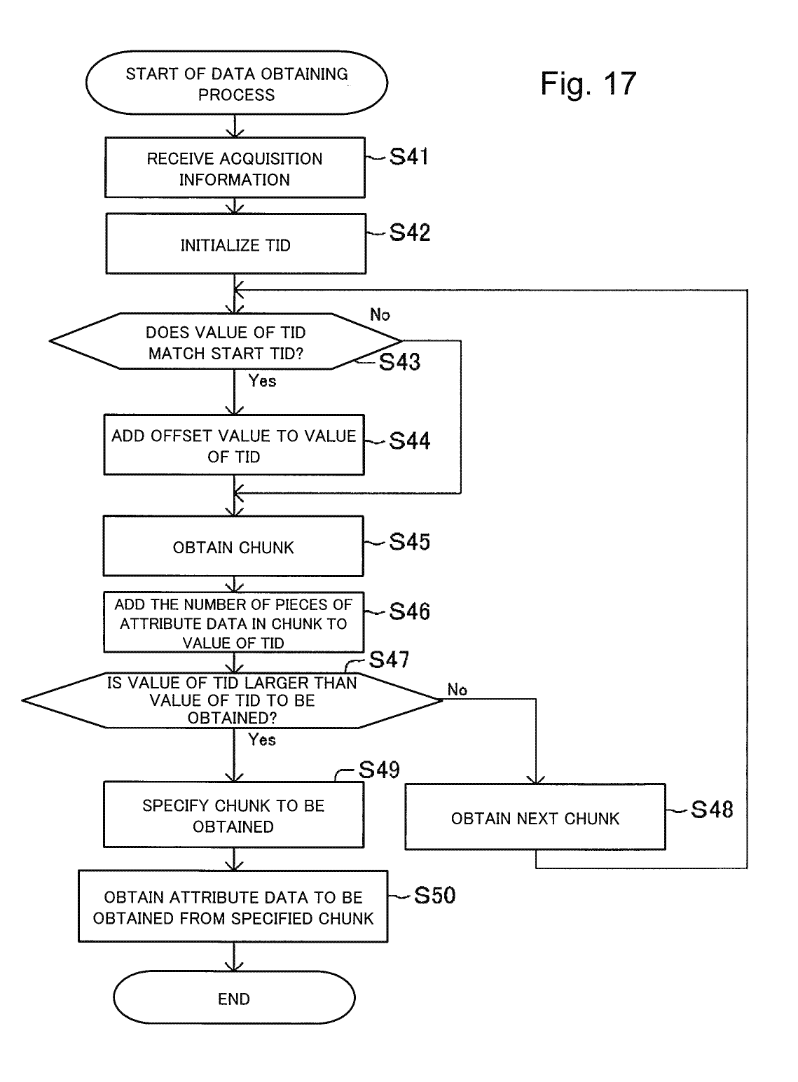

Next, referring to FIGS. 15 to 17, the above-described operation of the information processing apparatus 1 will be described specifically. FIG. 15 is a flowchart for explaining the data deleting process. FIG. 16 is a flowchart for explaining the data retrieving process. FIG. 17 is a flowchart for explaining the data obtaining process.

First, referring to FIG. 15, the data deleting process will be described. In the data deleting process, the query processing unit 41 receives deletion information (step S1). Deletion information is information expressing tuple data to be deleted. For example, the query processing unit 41 receives tuple data of TID 200 to 299 of the data 61 as deletion information. Subsequently, the query processing unit 41 deletes attribute data in the chunk (step S2). For example, the query processing unit 41 deletes the attribute data of TID 200 to 299 stored in each of the column data 21A and 21B.

The chunk deletion determining unit 43 determines whether all of attribute data in a predetermined chunk is deleted or not (step S3). When the chunk deletion determining unit 43 determines that all of attribute data in a predetermined chunk is deleted (step S3: Yes), the chunk deletion determining unit 43 releases the chunk from which all of the attribute data is deleted (step S4). For example, when attribute data of TID 200 to 299 is deleted by the query processing unit 41 in the column A, all of the attribute data stored in the chunk CA2 is deleted. Therefore, the chunk deletion determining unit 43 determines that the chunk CA2 can be deleted and releases the chunk CA2 in the column data 21.

Subsequently, the chunk deletion determining unit 43 deletes the information of the released chunk from the chunk list 22 (step S5). For example, the chunk deletion determining unit 43 deletes the chunk identification information “CA2” stored in the chunk list 22A of the column A. The column data managing unit 42 stores the information of the released chunk into the offset management table 23 (step S6). For example, when the chunk CA2 is released by the chunk deletion determining unit 43, the column data managing unit 42 stores the start TID (start data information) “200” which is TID of the first attribute data stored in the chunk CA2, into the offset management table 23A. The column data managing unit 42 also stores the offset value (the number of pieces of attribute data) “100” which is the number of pieces of attribute data stored in the chunk CA2, into the offset management table 23A.

Subsequently, the column data managing unit 42 determines whether common chunk information is stored in the offset management tables 23 for each column, or not (step S7). In the case where the column data managing unit 42 determines that information of a common chunk is stored in the offset management table 23 for each column (step S7: Yes), the TID is brought (advanced) forward on the basis of the information of the common chunk (step S8). As a result, in the case where the common TID range is TID 200 to 399, for example, when the query processing unit 41 executes a data process (for example, the data retrieving process or data obtaining process), the column data managing unit 42 brings the TID forward as follows. Specifically, the column data managing unit 42 sequentially brings forward the values of TID by 200 on the attribute data processed as TID 400 to 499 before the offset adjusting process (steps S7 and S8), and set the TID as 200 to 299 to those attribute data. After the process of step S8, or in the case where the determination result of the processes of steps S3 and S7 is ‘No’, the data deleting process is finished. In such a manner, the value of TID can be maintained as a small value, and digit overflow of the value of TID can be prevented. Therefore, the database can be operable for long time. The process of optimizing the offset management table 23 (steps S7 and S8) is not limited to be executed after the process of step S6 but can be executed at an arbitrary timing.

Next, the data retrieving process will be described with reference to FIG. 16. In the data retrieving process, the query processing unit 41 receives retrieval information (step S21). The retrieval information is information expressing attribute data to be retrieved. For example, the query processing unit 41 receives information that the attribute data of the column A is “XX-40” as retrieval information. Subsequently, the query processing unit 41 initializes TID (step S22). That is, the query processing unit 41 sets TID=0.

The query processing unit 41 determines whether there is the following (next) chunk or not (step S23). In the case where TID is initialized in the process of step S22 (for example, in the case where TID=0), the query processing unit 41 determines whether there is the chunk or not. When it is determined that there is the next chunk (step S23: Yes), the query processing unit 41 determines whether the value of TID matches the value of the start TID stored in the offset management table 23 (step S24). For example, referring to the offset management table 23A in FIG. 9, the query processing unit 41 determines that the value of start TID is “0” and the value of start TID matches the value of TID (step S24: Yes). In this case, the query processing unit 41 adds the offset value to the value of TID (step S25). For example, when referring to the offset management table 23 in FIG. 9, the offset value is set as “100”, so that the query processing unit 41 adds the offset value “100” to the value “0” of TID.

Subsequently, the query processing unit 41 obtains a chunk (step S26). More specifically, the query processing unit 41 obtains the chunk CA1 storing the value “100” of TID. The query processing unit 41 performs a matching process (step S27). More specifically, the query processing unit 41 performs a process of determining whether attribute data corresponding to the TID matches retrieval information or not. For example, the query processing unit 41 determines whether or not the attribute data corresponding to the value “100” of TID is “XX-40” obtained as the retrieval information. When it is determined that the attribute data corresponding to the TID matches the retrieval information, the query processing unit 41 obtains the value of TID which matches the retrieval information and holds it. Subsequently, the query processing unit 41 increments the value of TID by one (step S28). Then, the query processing unit 41 determines whether there is attribute data in a chunk or not (step S29). When the query processing unit 41 determines that there is still attribute data in the chunk (step S29: Yes), the process returns to step S27, and the subsequent processes are repeated. That is, the query processing unit 41 determines whether the attribute data corresponding to the value of TID which is incremented by one matches retrieval information or not (performs a matching process).

On the other hand, in the case where the query processing unit 41 determines that there is no attribute data in the chunk (step S29: No), the process returns to step S23, and the subsequent processes are repeated. When it is determined that there is no next chunk in the process of step S23 (step S23: No), the attribute and data retrieving process is finished. In such a manner, for example, the value of TID whose attribute data in the column A is “XX-40” can be retrieved.

As described above, regardless of the fact the chunk, in which all of attribute data is deleted, is released (deleted), the query processing unit 41 can execute the data retrieving process on attribute data stored in the column data 21 virtually.

Next, the data obtaining process will be described with reference to FIG. 17. In the data obtaining process, the query processing unit 41 receives acquisition information (step S41). The acquisition information is information expressing the value of TID to be obtained. For example, the query processing unit 41 receives TID “350” as acquisition information. Subsequently, the query processing unit 41 initializes TID (step S42). That is, the query processing unit 41 sets TID=0.

The query processing unit 41 determines whether the value of TID matches the value of start TID stored in the offset management table 23 or not (step S43). For example, referring to the offset management table 23A in FIG. 9, the query processing unit 41 determines that the value of start TID is “0”, and therefore the value of start TID matches the value of TID (step S43: Yes). In this case, the query processing unit 41 adds the offset value to the value of TID (step S44). For example, when referring to the offset management table 23 in FIG. 9, the offset value is set as “100”, so that the query processing unit 41 adds the offset value “100” to the value “0” of TID. After the process of step S44, or in the case where the determination result of the process of step S43 is ‘No’, the query processing unit 41 obtains a chunk (step S45). More specifically, the query processing unit 41 obtains the chunk CA1 storing the value “100” of TID.

Subsequently, the query processing unit 41 adds the number of pieces of attribute data of the chunk, to the value of TID (step S46). For example, the query processing unit 41 adds the number of pieces of attribute data “100” to the value of TID “100”. The query processing unit 41 determines whether the value of TID is larger than the value of TID to be obtained or not (step S47). For example, the value “200” of TID, to which the number of pieces of attribute data is added, is smaller than the value “350” of TID to be obtained. Therefore, the query processing unit 41 determines No in the process of step S47 and determines whether there is a next chunk or not (step S48). When the query processing unit 41 determines that there is a next chunk (step S48: Yes), the process returns to step S43 and the subsequent processes are repeated. That is, the query processing unit 41 executes the process in step S43 and subsequent steps on the basis of the value of TID to which the number of pieces of attribute data is added in step S46.

On the other hand, when the query processing unit 41 determines that the value of TID is larger than the value of TID to be obtained, in step S47 (step S47: Yes), a chunk to be obtained is specified (step S49). For example, the query processing unit 41 determines that the value “400” of TID exceeds the value “350” of TID to be obtained. Therefore, the query processing unit 41 specifies that attribute data corresponding to the TID “350” is stored in the chunk CA3. The query processing unit 41 obtains the attribute data to be obtained from the specified chunk (step S50). That is, the query processing unit 41 obtains the attribute data corresponding to the TID “350” from the chunk CA3. After the process of step S50, or when the determination result in step S48 is ‘No’, the data obtaining process is finished. As described above, regardless of the fact the chunk CA2 is deleted, the query processing unit 41 can execute the data obtaining process of obtaining attribute data corresponding to the TID “350”.

### Second Exemplary Embodiment

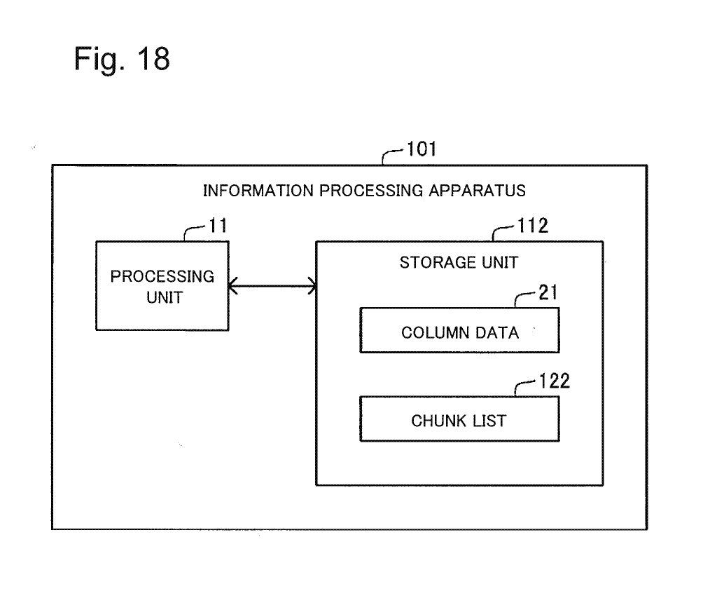

Next, a second exemplary embodiment of the present invention will be described with reference to FIGS. 18 to 23. FIGS. 18 to 23 are diagrams for explaining the configuration of an information processing apparatus 101.

(Configuration)

First, referring to FIG. 18, the information processing apparatus 101 will be described. FIG. 18 is a block diagram illustrating a configuration example of the information processing apparatus 101 in the exemplary embodiment. As illustrated in FIG. 18, the information processing apparatus 101 has the processing unit 11 and a storage unit 112. In the second exemplary embodiment, the same reference numeral is designated to a component corresponding to the information processing apparatus 1 in the first exemplary embodiment.

The processing unit 11 has a configuration similar to the processing unit 11 described with reference to FIGS. 4 and 5. The storage unit 112 has a configuration similar to the storage unit 12 in FIG. 4 and stores the column data 21 and a chunk list 122. The column data 21 has a configuration similar to that of the first exemplary embodiment. The details of the column data 21 and the chunk list 122 will be described later.

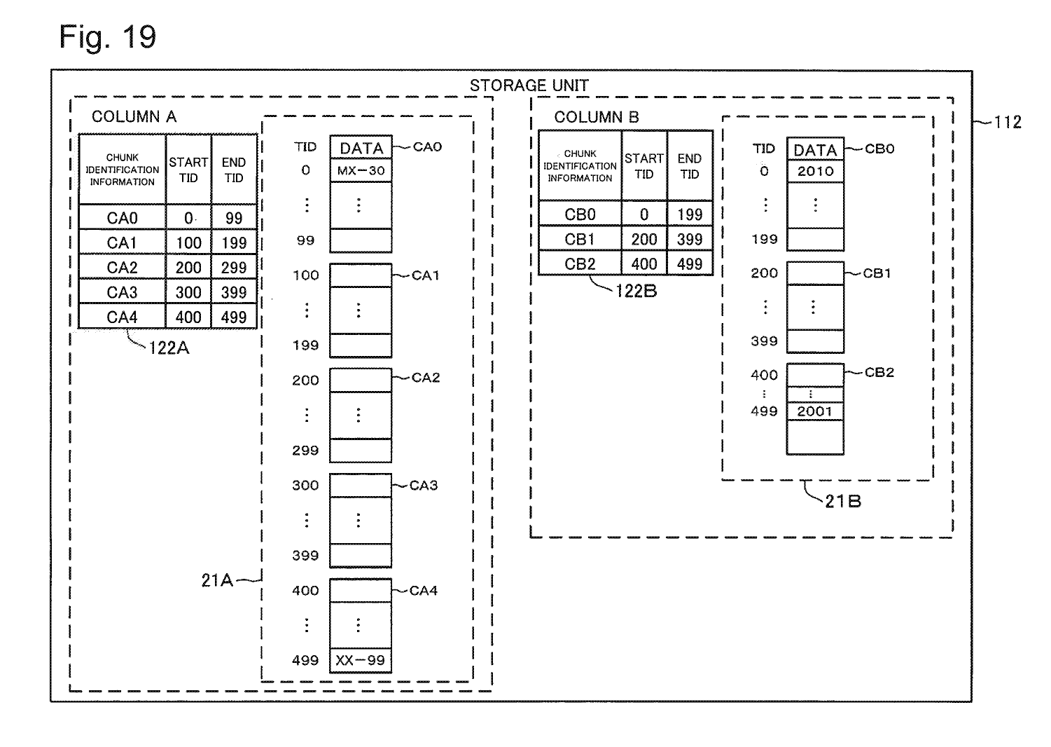

The column data managing unit 42 arranges the attribute data of the tuple data, for each column (attribute), for example, in the data 61 of the tabular form of FIG. 6. And then The column data managing unit 42 stores the arranged attribute data to the column data 21 in the storage unit 12. FIG. 19 is a diagram illustrating an example of the storage unit 112. As illustrated in FIG. 19, in the column data 21, attribute data in the column A and attribute data in the column B is stored in chunks as a plurality of storage regions having a predetermined size.

For example, it is assumed that the chunk size is a fixed length of 400 bytes and the size of one piece of attribute data in the column A is four bytes. In this case, the entire storage capacity of the attribute data of the column A is 2,000 bytes (4 bytes×500 pieces). Since one hundred pieces of attribute data can be stored in one chunk, the column data managing unit 42 obtains five chunks CA0 to CA4 as illustrated in FIG. 19 and sequentially stores attribute data of the column A in the data 61.

The column data managing unit 42 stores, into the chunk list 122, pointer information such as addresses and identification information by which a plurality of chunks stored in the column data 21 can be specified. The column data managing unit 42 also stores the start TID (start data information), which is TID of attribute data stored at the head of the chunk, into the chunk list 122. The column data managing unit 42 stores end TID (end data information), which is TID of attribute data stored at the end of the chunk, into the chunk list 122. For example, the column data managing unit 42 stores, in a chunk list 122A of the column A, each of the chunk identification information CA0 to CA4 and start TID and end TID of a chunk corresponding to each of the chunk identification information CA0 to CA4 so as to be associated with each other.

On the other hand, it is assumed that the size of one piece of attribute data in the column B is two bytes, for example. In this case, the entire storage capacity of the attribute data of the column B is 1000 bytes (2 bytes×500 pieces). 200 pieces of attribute data can be stored in one chunk. As illustrated in FIG. 19, the column data managing unit 42 obtains three chunks CB0 to CB2 and sequentially stores the attribute data of the column B of the data 61. The column data managing unit 42 stores, in a chunk list 122B of the column B, each of the chunk identification information CB0 to CB2 and start TID and end TID of a chunk corresponding to each of the chunk identification information CB0 to CB2 so as to be associated with each other.

With the arrangement, when the query processing unit 41 executes predetermined processes (a data deleting process, a data retrieving process, and a data obtaining process which will be described later) on the data 61, the column data managing unit 42 can read the attribute data from an arbitrary chunk. Therefore, even in the case where the number of chunks is large, the column data managing unit 42 can more promptly obtain the attribute data of a predetermined column requested by the query processing unit 41.

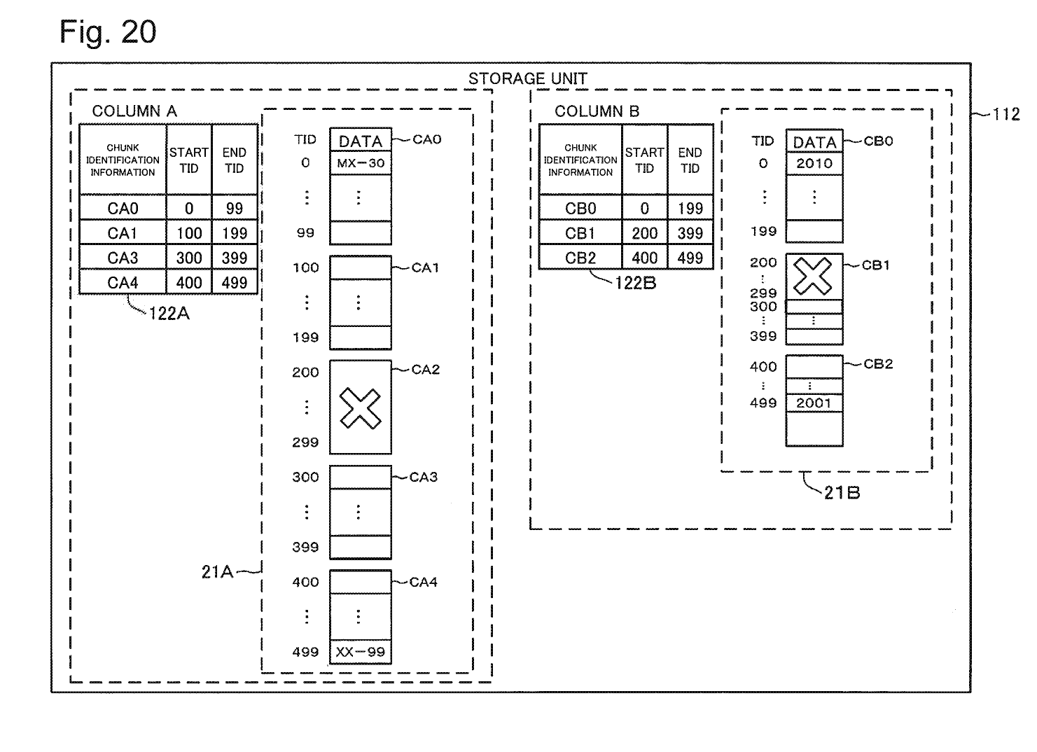

Next, each of the data deleting process, the data retrieving process, and the data obtaining process executed on the data 61 by the query processing unit 41 will be described. First, referring to FIG. 20, the data deleting process will be described. In the following, the case that the query processing unit 41 receives a request of deleting 100 pieces of tuple data of TID 200 to 299 from the user via an input apparatus (not illustrated) will be described. In this case, the query processing unit 41 deletes tuple data of TID 200 to 299 in the data 61. More specifically, the query processing unit 41 deletes each of the attribute data of TID 200 to 299 stored in the column data 21A and 21B.

The chunk deletion determining unit 43 determines whether or not a chunk can be deleted by the data deleting process of the query processing unit 41. More specifically, the chunk deletion determining unit 43 obtains, for the each column, deletion data information. The deletion data information expresses information specifying the order (TID) in a tabular form, of tuple data including the attribute data deleted from chunks set for each column, by the query processing unit 41. For example, when attribute data of TID 200 to 299 is deleted by the query processing unit 41 in the column A, the chunk deletion determining unit 43 obtains TID 200 to 299 as deletion data information. On the basis of the obtained deletion data information, the chunk deletion determining unit 43 determines that all of the attribute data stored in the chunk CA2 is deleted. Therefore, the chunk deletion determining unit 43 determines that the chunk CA2 can be deleted and releases the chunk CA2 in the column data 21.

The chunk deletion determining unit 43 deletes the chunk identification information “CA2”, the start TID “200”, and the end TID “299” stored in the chunk list 122A of the column A of FIG. 20. By the operation, the chunk deletion determining unit 43 updates the chunk list 122A (stores deletion data information).

On the other hand, in the case where attribute data of TID 200 to 299 is deleted by the query processing unit 41 in the column B, a part of the attribute data stored in the chunk CB1 is deleted. However, the attribute data of TID 300 to 399 is still stored in the chunk CB1. Therefore, the chunk deletion determining unit 43 determines that the chunk CB1 cannot be deleted and does not release the chunk CB1.

In such a case, the column data managing unit 42 does not advance the TID stored in the chunks CA3 and CA4 after the chunk CA2 in the column A. Consequently, even when a chunk is released, consistency of the information of tuples can be maintained.

Next, processes, in the case where the query processing unit 41 performs a data retrieving process, after having performed a process of deleting the attribute data of TID 200 to 299, will be described below. In this example, processes to retrieve a TID (tuple) whose attribute data in the column A is “XX-40” and whose attribute data in the column B is “2000”, from the data 61 of FIG. 6, will be described.

The query processing unit 41 refers to the chunk list 122A in the column A of FIG. 20 and extracts chunks in order of CA0, CA1, CA3, and CA4. The query processing unit 41 determines whether the attribute data in the extracted chunks matches “XX-40” or not. For example, the query processing unit 41 determines whether the attribute data of TID “0” in the extracted chunk CA0 matches “XX-40” or not. Subsequently, the query processing unit 41 increments the value of TID by one each time the attribute data in a chunk is extracted and determines whether the attribute data corresponding to the TID incremented by one matches “XX-40” or not. In the case of referring to attribute data in a new chunk (in the case where the value of TID reaches to the end TID of a chunk referred to), the query processing unit 41 refers to the chunk list 122A and sets (initializes) the value of TID to the start TID of the chunk.

Since the chunk CA2 has been already deleted, no process is performed for tha chunk CA2. Therefore, when the value of TID becomes “199”, for example, the query processing unit 41 refers to the chunk list 122A and sets the value of TID as the start TID “300” of CA3. The query processing unit 41 determines whether the attribute data of TID “300” matches “XX-40” or not. Subsequently, the query processing unit 41 repeats the above-described data retrieving process.

As a result, without referring to the deleted chunk CA2, the query processing unit 41 executes the data retrieving process on the chunk CA3 storing attribute data after the chunk CA2. As described above, regardless of the fact that the chunk CA2 is deleted, the query processing unit 41 can execute the data retrieving process of attribute data of TID 0 to 499 stored in the column data 21A, virtually.

The query processing unit 41 refers to the chunk list 122B in the column B and extracts chunks in order of CB0, CB1, and CB2. The query processing unit 41 determines whether attribute data in the extracted chunk matches “2000” or not. For example, the query processing unit 41 determines whether the attribute data of TID “0” in the extracted chunk CB0 matches “2000” or not. Subsequently, the query processing unit 41 increments the value of TID by one each time the attribute data in a chunk is extracted and determines whether the attribute data corresponding to the TID incremented by one matches “2000” or not.

When the value of TID becomes the end TID of a chunk referred to, the query processing unit 41 refers to the chunk list 122B and sets (initializes) the value of TID to the start TID of a next extracted chunk. The query processing unit 41 executes the data retrieving process on the attribute data of TID 0 to 499 in the column B in order.

As described above, even in the case where one chunk in the column A is released, without causing a mismatch between the TID in the column A and the TID in the column B, the query processing unit 41 can reliably execute the data retrieving process.

Next, processes in the case where the query processing unit 41 performs a data obtaining process, after having performed a process of deleting the attribute data of TID 200 to 299, will be described below. In this example, processes to obtain attribute data corresponding to TID “350” will be described, for example.

The query processing unit 41 refers to the chunk list 122A in the column A and extracts chunks in order of CA0, CA1, CA3, and CA4. The query processing unit 41 sets (initializes) the start TID of the extracted chunk to the value of TID. Subsequently, the query processing unit 41 determines whether the value of TID added exceeds “350” or not. For example, the query processing unit 41 determines whether the start TID “0” in the extracted chunk CA0 exceeds “350” or not. When it is determined that the start TID “0” does not exceed “350”, the query processing unit 41 extracts the chunk CA1 and sets the start TID “100” of the chunk CA1, to the value of TID.

After performing similar processes, the query processing unit 41 determines that the start TID “400” of the chunk CA4 exceeds “350”. and it is clarified that attribute data corresponding to TID “350” is stored in the chunk CA3. Therefore, the query processing unit 41 obtains the attribute data corresponding to TID “350” from the chunk CA3. As described above, regardless of the fact that the chunk CA2 is deleted, the query processing unit 41 can execute the data obtaining process of obtaining attribute data corresponding to TID “350”.

The query processing unit 41 refers to the chunk list 122B in the column B and extracts chunks in order of CB0, CB1, and CB2. The query processing unit 41 sets (initializes) the start TID of the extracted chunk to the value of TID. The query processing unit 41 determines whether the value of TID added exceeds “350” or not. In the column B, the query processing unit 41 extracts the chunk CB2 and determines that the start TID “400” of the chunk CB2 exceeds “350”. Therefore, the query processing unit 41 obtains attribute data corresponding to TID “350” from the chunk CB1.

As described above, even in the case where one chunk in the column A is released, without causing a mismatch between the TID in the column A and the TID in the column B, the query processing unit 41 can reliably execute the data obtaining process. By referring to the chunk list 122, the start TID of each of chunks can be referred. Consequently, the query processing unit 41 can start the data obtaining process from an arbitrary chunk. As a result, as compared with the case of incrementing the value of TID by one sequentially from the head of a chunk list as in the first exemplary embodiment, the query processing unit 41 can execute the data obtaining process more promptly. In addition, since the data obtaining process can be executed from an arbitrary chunk, the query processing unit 41 can execute the data obtaining process promptly and efficiently by parallel processing. Further, since attribute data is obtained by designating TID, it is unnecessary to calculate TID from the head in a chunk and, for example, a process such as binary search can be executed. Consequently, the query processing unit 41 can obtain desired attribute data more promptly.

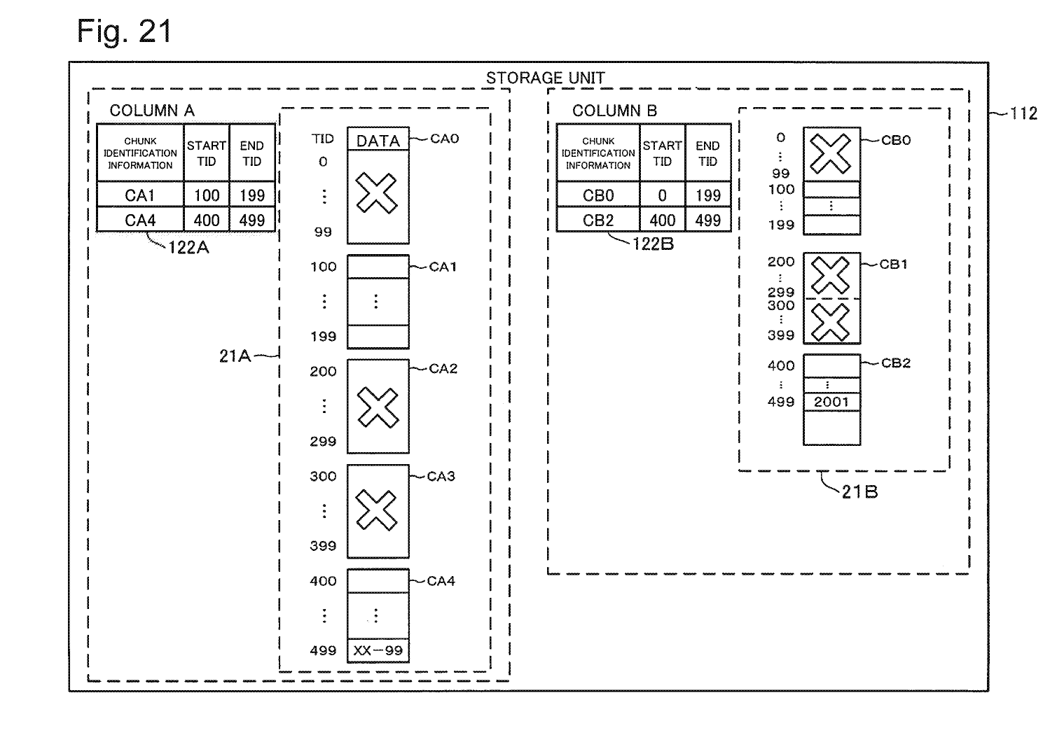

Referring now to FIG. 21, a case will be described in which the query processing unit 41 performs a process of deleting attribute data of TID 200 to 299 and, after that, receives a request of deleting 100 pieces of tuple data corresponding to TID 0 to 99, and 100 pieces of tuple data corresponding to TID 300 to 399 from the user via an input apparatus (not illustrated). In this case, the query processing unit 41 deletes the tuple data of TID 0 to 99 and the tuple data of TID 300 to 399. More specifically, the query processing unit 41 deletes each of the attribute data of TID 0 to 99 and each of the attribute data of TID 300 to 399 stored in the columns in the column data 21.

The chunk deletion determining unit 43 determines whether a chunk can be deleted or not after the data deleting process of the query processing unit 41. In the case where the attribute data of TID 0 to 99 is deleted by the query processing unit 41 in the column A, all of the attribute data stored in the chunk CA0 is deleted. Therefore, the chunk deletion determining unit 43 determines that the chunk CA0 can be deleted and releases the chunk CA0 in the column data 21. Similarly, in the case where the attribute data of TID 300 to 399 is deleted by the query processing unit 41 in the column A, all of the attribute data stored in the chunk CA3 is deleted. Therefore, the chunk deletion determining unit 43 determines that the chunk CA3 can be deleted and releases the chunk CA3 in the column data 21.

The chunk deletion determining unit 43 deletes the chunk identification information “CA0”, the start TID “0”, and the end TID “99” stored in the chunk list 122A in the column A of FIG. 20. The chunk deletion determining unit 43 deletes the chunk identification information “CA3”, the start TID “300”, and the end TID “399”.

On the other hand, in the case where the attribute data of TID 0 to 99 is deleted by the query processing unit 41 in the column B, although a part of the attribute data stored in the chunk CB0 is deleted, the attribute data is still stored in the chunk CB0. Therefore, the chunk deletion determining unit 43 determines that the chunk CB0 cannot be deleted, and does not release the chunk CB0. In the case where the attribute data of TID 300 to 399 is deleted by the query processing unit 41 in the column B, all of the attribute data stored in the chunk CB1 is deleted. Therefore, the chunk deletion determining unit 43 determines that the chunk CB1 can be deleted and releases the chunk CB1 in the column data 21.

The chunk deletion determining unit 43 deletes the chunk identification information “CB1”, the start TID “200”, and the end TID “399” stored in the chunk list 122B in the column B in FIG. 20. In the case where the data retrieving process and the data obtaining process are executed by the query processing unit 41, since the start TID and the end TID of each chunk are stored, consistency of TID can be maintained between the columns.

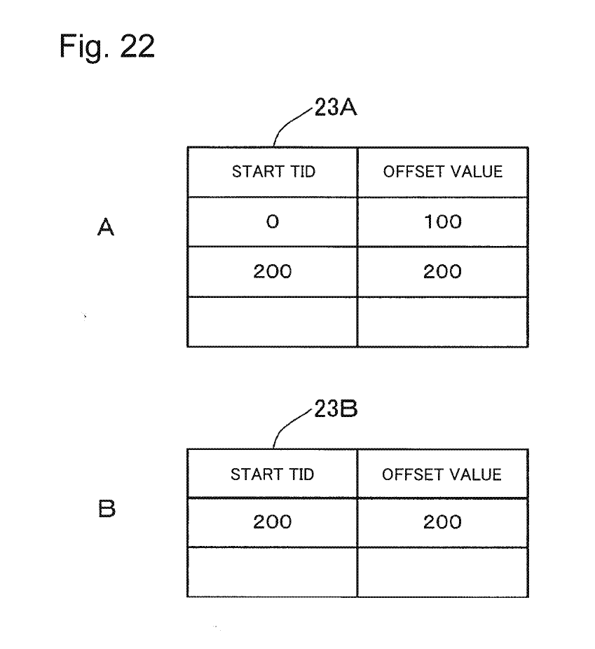

Next, a process for preventing digit overflow of the value of TID will be described. The offset adjusting unit 44 (or the column data managing unit 42) generates the offset management table 23 with reference to the chunk list 122 at an arbitrary timing. An arbitrary timing is, for example, a timing when a predetermined time has elapsed, a timing when a chunk is released by the chunk deletion determining unit 43, a timing when the predetermined number of pieces of attribute data stored in a chunk is deleted, or the like. More specifically, with reference to the chunk list 122, the offset adjusting unit 44 determines whether the value of the end TID of a predetermined chunk and the value of the start TID of a chunk subsequent to the predetermined chunk are continuous or not. When it is determined that the value of the end TID of a predetermined chunk and the value of the start TID of the next chunk are not continuous, the offset adjusting unit 44 regards that a deleted chunk exists. Note that the initial value of the start TID of the first chunk is “0”. When the start TID of the first chunk stored in the chunk list 122 is not “0”, the offset adjusting unit 44 regards that the first chunk is deleted. Subsequently, the offset adjusting unit 44 generates the offset management table 23 (FIG. 22) in which the start TID of a deleted chunk and the number of pieces of attribute data (offset value) of the deleted chunk are stored.

For example, the offset adjusting unit 44 refers to the chunk list 122A of the column A and regards that the chunk identification information “CA0”, “CA2”, and “CA3” is deleted. Therefore, the offset adjusting unit 44 generates the offset management table 23A (FIG. 22A) in which the start TID of a deleted chunk and the number of pieces of attribute data of the deleted chunk are stored. Similarly, the offset adjusting unit 44 refers to the chunk list 122B of the column B and regards that the chunk identification information “CB1” is deleted. Therefore, the offset adjusting unit 44 generates the offset management table 23B (FIG. 22B) in which the start TID of a deleted chunk and the number of pieces of attribute data of the chunk are stored.

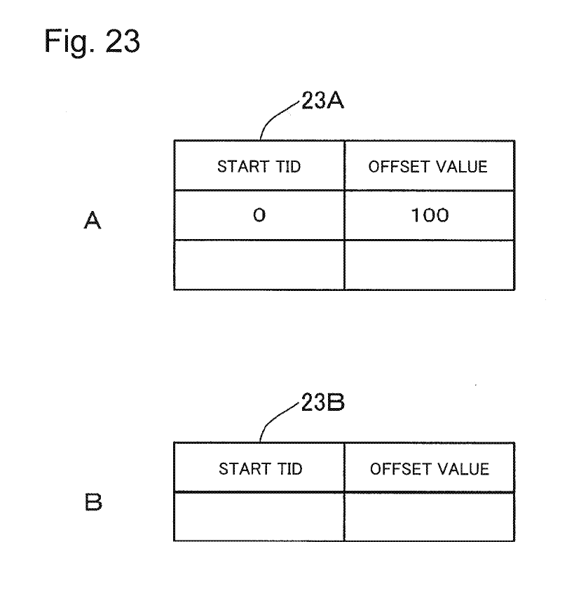

In a manner similar to the first exemplary embodiment, the offset adjusting unit 44 refers to the offset management tables 23A and 23B in FIG. 22 and determines whether there is a common TID range (deletion data information) or not. In the example of FIG. 22, the start TID “200” and the offset value “200” in the column A and those in the column B are to match (are common). Therefore, even when the information of the start TID “200” and the offset value “200” is deleted, mismatch of TID does not occur when a predetermined process is executed by the query processing unit 41. Thus, as illustrated in FIGS. 23A and 23B, the offset adjusting unit 44 deletes the start TID “200” and the offset value “200” stored in each of the offset management tables 23A and 23B.

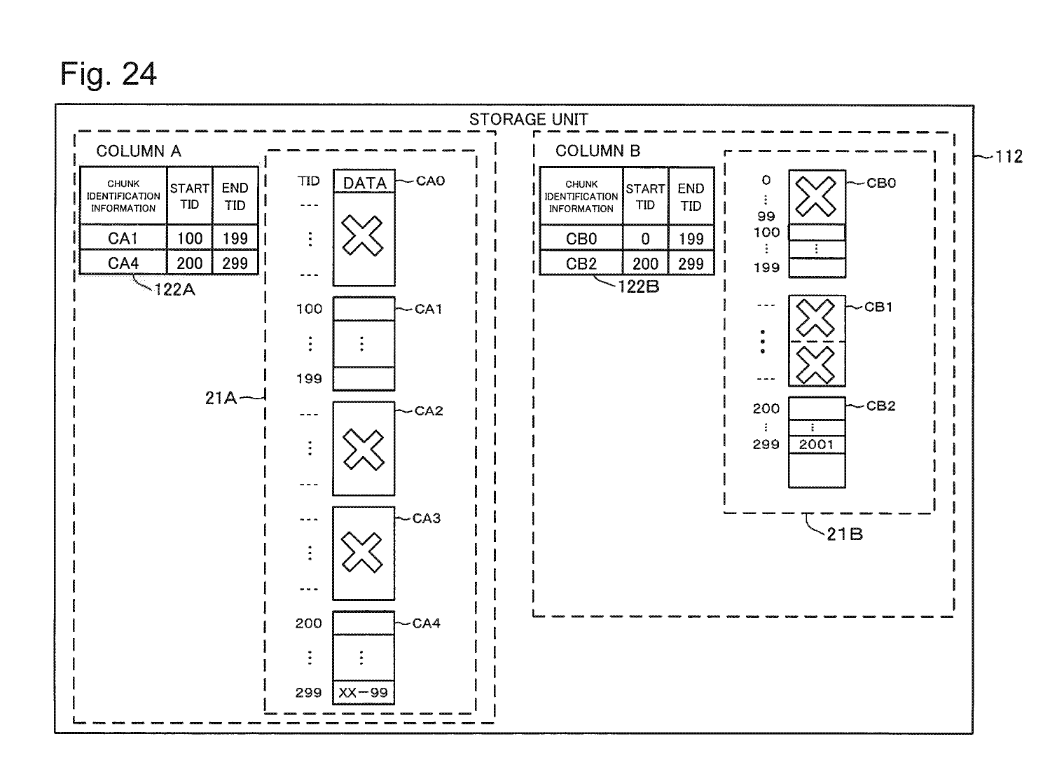

Simultaneously, the column data managing unit 42 refers to the chunk list 122 and advances the value of the start TID (the order in the tabular form of attribute data) and the value of the end TID of a chunk storing attribute data after the released chunk, corresponding to the common TID range (deletion data information). More specifically, when the common TID range is TID 200 to 399, as illustrated in FIG. 24, the column data managing unit 42 sequentially advances the value of TID 400 to 499 by the offset value “200” (the number of pieces of attribute data). And the column data managing unit 42 can set those TID as 200 to 299. In such a manner, the value of TID can be maintained at a small value, and digit overflow of the TID value can be prevented. Therefore, a database can be operable for long time. Although, in the above description, specification of a common part and updating of the chunk list 122 are sequentially performed, it is also possible to calculate a cumulative total value of TID to be advanced after specifying all of common parts, and to update the chunk list 122.

The offset adjusting unit 44 can advance the value of TID on the basis of a common TID range with reference to the chunk list 122 without generating the offset management table 23. For example, the offset adjusting unit 44 determines whether common start TID and end TID is included in each of the chunk lists 122 obtained by the columns. In the example of FIG. 21, the offset adjusting unit 44 refers to the chunk list 122A and specifies that each of the chunk of TID 0 to 99 and the chunk of TID 200 to 399 is deleted (released). The offset adjusting unit 44 refers to the chunk list 122B and specifies that the chunk of TID 200 to 399 is deleted. Therefore, the offset adjusting unit 44 advances the value of TID in a chunk storing attribute data after the chunk corresponding to the common start TID “200” and the end TID “399”. The offset adjusting unit 44 calculates, for example, “(value of end TID)−(value of start TID)+1” to calculate a value for advancing TID.

### Third Exemplary Embodiment

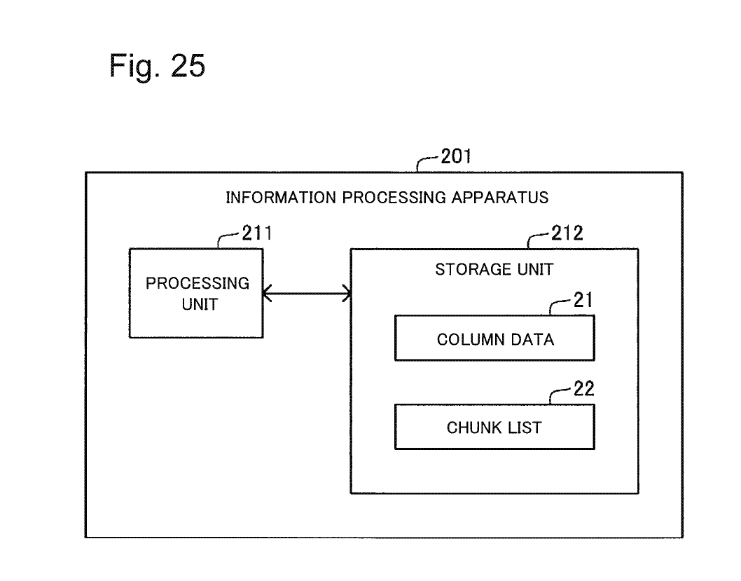

Next, a third exemplary embodiment of the present invention will be described with reference to FIGS. 25 to 28. FIGS. 25 to 28 are diagrams for explaining the configuration of an information processing apparatus 201.

(Configuration)

First, referring to FIG. 25, the information processing apparatus 201 will be described. FIG. 25 is a block diagram illustrating a configuration example of the information processing apparatus 201 in the exemplary embodiment. As illustrated in FIG. 25, the information processing apparatus 201 includes an processing unit 211 and a storage unit 212. In the third exemplary embodiment, the same reference numerals are designated to components corresponding to those in the information processing apparatus 1 in the first exemplary embodiment or those in the information processing apparatus 101 in the second exemplary embodiment.

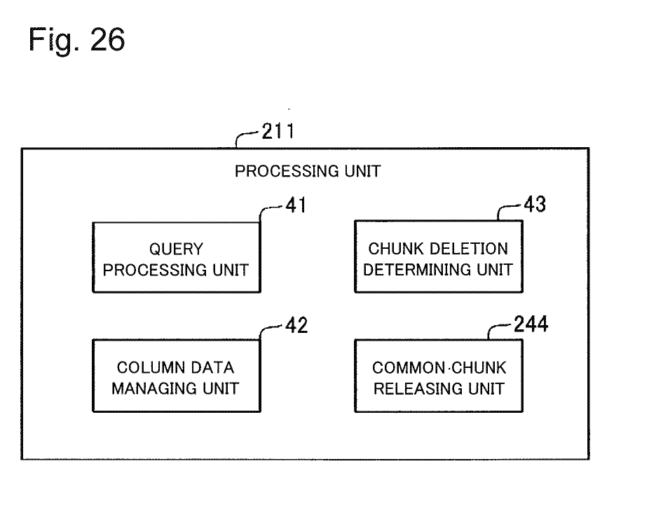

As illustrated in FIG. 26, the processing unit 211 includes functional blocks of the query processing unit 41, the column data managing unit 42, the chunk deletion determining unit 43, and a common chunk releasing unit 244 (data managing means). The storage unit 212 has a configuration similar to that of the storage unit 12 in FIG. 4, and stores the column data 21 and the chunk list 22. Each of the column data 21, the chunk list 22, and the chunk deletion determining unit 43 has a configuration similar to that in the first exemplary embodiment.

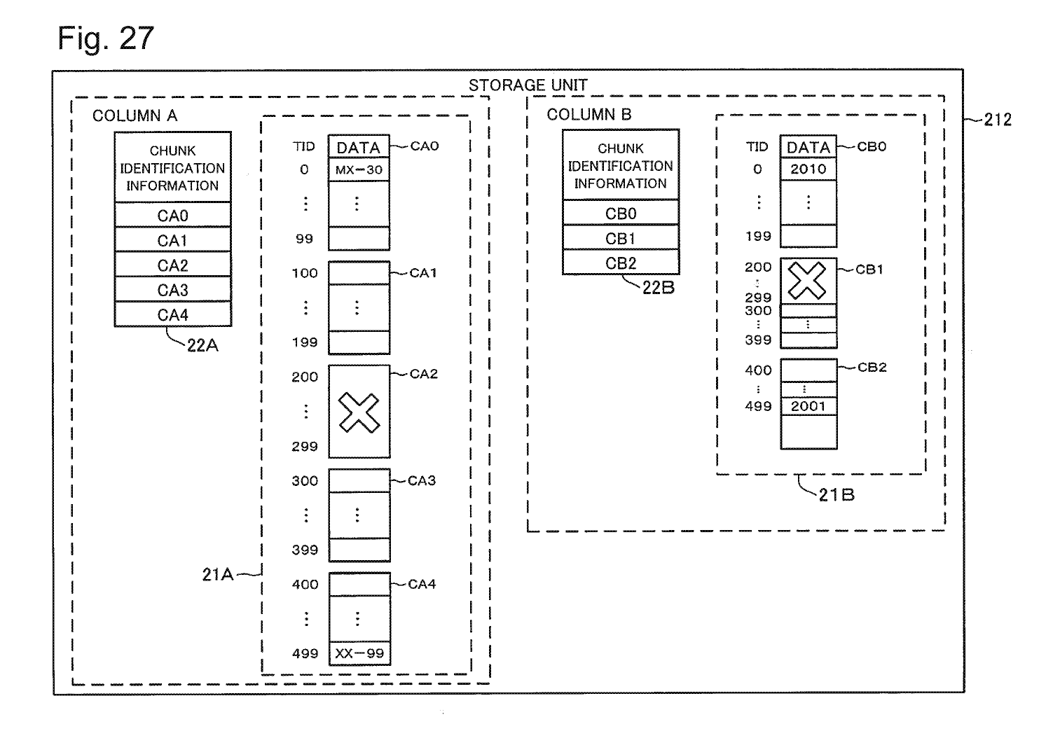

Referring now to FIG. 27, the data deleting process will be described. In the following, the case that the query processing unit 41 receives a request of deleting 100 pieces of tuple data of TID 200 to 299 from the user via an input apparatus (not illustrated) will be described. In this case, the query processing unit 41 deletes the tuple data of TID 200 to 299 in the data 61. More specifically, the query processing unit 41 deletes each of the attribute data of TID 200 to 299 in chunks stored in the column data 21A and 21B.

The chunk deletion determining unit 43 determines whether a chunk can be deleted or not after the data deleting process of the query processing unit 41. For example, in the case where the attribute data of TID 200 to 299 is deleted by the query process unit 41 in the column A, the chunk deletion determining unit 43 obtains TID 200 to 299 as deletion data information. At this time, all of attribute data stored in the chunk CA2 is deleted. In the case where all of the attribute data in the chunk is deleted, the chunk deletion determining unit 243 determines that the chunk CA2 can be deleted. The chunk deletion determining unit 43 can store obtained deletion data information into the storage unit 212.

On the other hand, when the attribute data of TID 200 to 299 is deleted by the query processing unit 41 in the column B, the chunk deletion determining unit 43 obtains TID 200 to 299 as deletion data information. At this time, a part of attribute data stored in the chunk CB1 is deleted but attribute data TID 300 to 399 is still stored in the chunk CB1. In the case where not all of the attribute data in the chunk is deleted, the chunk deletion determining unit 43 determines that the chunk CB1 cannot be deleted.

Therefore, the common chunk releasing unit 244 obtains deletion data information of TID 200 to 299 of a chunk which can be deleted in the column A and information that there is no chunk which can be deleted in the column B as a determination result of the chunk deletion determining unit 43. As a result, the common chunk releasing unit 244 determines that there is no common deletion data information and does not release the chunk CA2 in the column A.

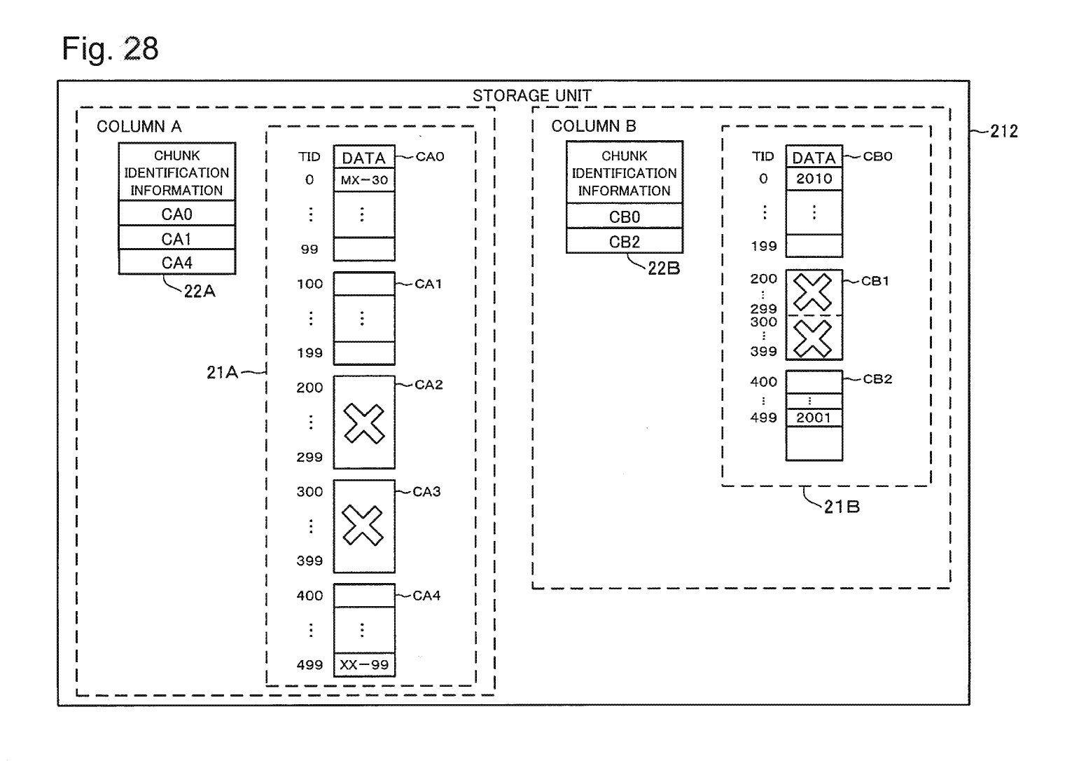

Referring now to FIG. 28, a case will be described in which the query processing unit 41 receives a request of deleting 100 pieces of tuple data of TID 300 to 399 from the user via an input apparatus (not illustrated). In this case, the query processing unit 41 deletes the tuple data of TID 300 to 399 in the data 61. More specifically, the query processing unit 41 deletes each of the attribute data of TID 300 to 399 in chunks stored in the column data 21A and 21B.

The chunk deletion determining unit 43 determines whether a chunk can be deleted or not after the data deleting process of the query processing unit 41. In the case where the attribute data of TID 300 to 399 is deleted by the query processing unit 41 in the column A, the chunk deletion determining unit 43 obtains TID 200 to 299 as stored deletion data information. In addition, the chunk deletion determining unit 43 obtains TID 300 to 399 as deletion data information newly added. In the case where the deletion data information is not stored in the storage unit 212, the chunk deletion determining unit 43 can retrieve a chunk from which all of attribute data is deleted with reference to the column data 21 stored in the storage unit 212. The chunk deletion determining unit 43 can obtain information of the start TID and the end TID of the chunk as deletion data information.

When the attribute data of TID 300 to 399 is deleted by the query processing unit 41, all of the attribute data stored in the chunks CA2 and CA3 is deleted. In this case, the chunk deletion determining unit 243 determines that the chunks CA2 and CA3 can be deleted.

In the case where attribute data of TID 300 to 399 is deleted by the query processing unit 41 in the column B, the chunk deletion determining unit 43 obtains TID 200 to 299 as stored deletion data information. In addition, the chunk deletion determining unit 43 obtains TID 300 to 399 as newly added deletion data information. At this time, all of the attribute data stored in the chunk CB1 is deleted. In this case, the chunk deletion determining unit 43 determines that the chunk CB1 can be deleted.

Next, the common chunk releasing unit 244 obtains deletion data information of TID 200 to 399 of a chunk which can be deleted in the column A as a determination result of the chunk deletion determining unit 43. The common chunk releasing unit 244 also obtains the deletion data information of TID 200 to 399 which can be deleted in the column B. As a result, the common chunk releasing unit 244 determines that TID 200 to 399 are common deletion data information. In the case where common deletion data information exists as described above, the common chunk releasing unit 244 releases chunks (for example, the chunks CA2 and CA3 in the column A and the chunk CB1 in the column B) corresponding to the common deletion data information. The common chunk releasing unit 244 advances the TID in a chunk storing attribute data after the released chunk. The common chunk releasing unit 244 calculates, for example, “(value of end TID (for example, TID=399))−(value of start TID (for example, TID=200))+1” to calculate a value of advancing TID. In the case where a chunk is released, the common chunk releasing unit 244 deletes information corresponding to the released chunk from the chunk list 122.

As described above, the information processing apparatus 201 executes releasing of a chunk and advancing of the value of TID at the same timing. Therefore, in the case where the query processing unit 41 executes the data retrieving process or the data obtaining process, it is unnecessary to refer to the offset management table 23 or the like. Consequently, the information processing apparatus 201 can execute the data retrieving process and the data obtaining process easily and promptly.

Although the present invention has been described above with reference to the foregoing exemplary embodiments, the invention is not limited to the above-described exemplary embodiments. Various changes which can be understood by a person skilled in the art can be performed on the configuration and details of the present invention within the scope of the invention.

### SUPPLEMENTAL NOTES

A part or all of the foregoing exemplary embodiments can be also described as the following supplemental notes. Hereinbelow, outline of the configuration of an information processing apparatus and the like in the present invention will be descried. However, the present invention is not limited to the following configuration.

### Supplemental Note 1

An information processing apparatus including:

data managing means for storing data in a tabular form in which a group of tuple data made by a plurality of pieces of attribute data is positioned in a row direction and the attributes are positioned in a column direction so that the tuple data is put together by the attribute data into a storage apparatus; and

data processing means for executing a predetermined process on the database,

wherein the data managing means stores attribute data constructing the tuple data into a plurality of chunks each having a storage region of a predetermined capacity set for each of the attribute data in order that the tuple data is positioned in the tabular form, obtains, by the attributes, deletion data information expressing information specifying the order in the tabular form of the tuple data including the attribute data deleted from the chunk set by the attributes by the data processing means, and releases the chunk on the basis of the deletion data information.

With the configuration, in the case of managing tuple data in a database by attributes, when attribute data stored in a chunk is deleted, deletion data information specifying the order in a tabular form of tuple data including the deleted attribute data is obtained, and a chunk is released on the basis of the deletion data information. Consequently, while maintaining consistency of tuple data in a plurality of attributes, a storage region can be reduced.

### Supplemental Note 2

In the information processing apparatus described in the supplemental note 1, when the attribute data is deleted from the chunk by the data processing means, the data managing means stores the deletion data information specifying the order in the tabular form of the tuple data including the attribute data by the attributes into the storage apparatus, obtains the deletion data information by the attributes stored, and releases the chunk on the basis of the deletion data information.

With the configuration, deletion data information is stored by attributes and a chunk is released on the basis of the stored deletion data information. Consequently, while maintaining consistency of tuple data in a plurality of attributes, a storage region can be reduced.

### Supplemental Note 3

In the information processing apparatus described in the supplemental note 1 or 2, when all of the attribute data stored in a predetermined chunk is deleted, the data managing means stores the deletion data information specifying the order in the tabular form of the tuple data including the attribute data deleted from the chunk by the attributes into the storage apparatus, and releases the chunk.

With the configuration, in the case where all of attribute data in a chunk is deleted, deletion data information corresponding to the chunk is stored, and the chunk is released on the basis of the stored deletion data information. Therefore, management of chunks is facilitated and, while maintaining consistency of tuple data in a plurality of attributes, a storage region can be reduced.

### Supplemental Note 4

In the information processing apparatus described in any one of the supplemental notes 1 to 3,

when common deletion data information is included in each of the deletion data information obtained by the attributes, the data managing means deletes the common deletion data information, thereby advancing the order in the tabular form of the attribute data in a chunk storing the attribute data after the released chunk, corresponding to the common deletion data information deleted.

With the configuration, in the case where common deletion data information is included in each of deletion data information obtained by attributes, the order in the tabular form of the attribute data is advanced. Therefore, the digit of the order can be prevented from being overflown.

### Supplemental Note 5

In the information processing apparatus described in any one of the supplemental notes 1 to 4,

the data managing means obtains, as the deletion data information obtained by the attributes, start data information specifying the order in the tabular form of the attribute data stored at the head of the chunk and the number of pieces of attribute data as the number of pieces of the attribute data stored in the chunk, and in the case where the start data information and the number of pieces of attribute data which is common is included in each of the deletion data information by the attributes, by deleting the start data information and the number of pieces of attribute data which is common, advances the order in the tabular form of the attribute data in a chunk storing the attribute data after the released chunk, corresponding to the common deletion data information only by the number of pieces of the attribute data.

With the configuration, start data information and the number of pieces of attribute data of a deleted chunk is obtained and, on the basis of the start data information and the number of pieces of attribute data obtained, the order in the tabular form of the attribute data is advanced. Therefore, consistency of tuple data in a plurality of attributes can be maintained, and the digit of the order can be prevented from being overflown.

### Supplemental Note 6

In the information processing apparatus described in the supplemental notes 1 to 4,

the data managing means obtains, from each of the chunks by the attributes, start data information specifying the order in the tabular form of the attribute data stored at the head of the chunk and end data information specifying the order in the tabular form of the attribute data stored at the end of the chunk, in the case where the start data information and the end data information is not continuous, obtains, as the deletion data information, information specifying the order in the tabular form of the attribute data in a discontinuous range and, in the case where common start data information and common end data information is included in each of the deletion data information by the attributes, deletes the common start data information and the common end data information to advance the start data information and the end data information by the attributes, thereby advancing the order in the tabular form of the attribute data in a chunk storing the attribute data after the released chunk.

With the configuration, start data information and end data information of a deleted chunk is obtained and, on the basis of the start data information and the end data information obtained, the order in the tabular form of the attribute data is advanced. Consequently, consistency of tuple data in a plurality of attributes can be maintained, and the digit of the order can be prevented from being overflown.

### Supplemental Note 7

The information processing apparatus described in the supplemental note 1,

in the case where the common deletion data information is included in each of the deletion data information obtained by the attributes and the common deletion data information expresses that all of the attribute data stored in a predetermined chunk is deleted, the data managing means releases the chunk corresponding to the common deletion data information and advances the order in the tabular form of the attribute data in a chunk storing the attribute data after the released chunk.

With the configuration, release of a chunk and advancing of the order are executed at the same timing. Consequently, in the case where a process is executed by the data processing means, without necessity of referring to deletion data information, a process can be executed promptly.

### Supplemental Note 8

A program for making an information processing apparatus realize:

data managing means for storing data in a tabular form in which a group of tuple data made by a plurality of pieces of attribute data is positioned in a row direction and the attributes are positioned in a column direction so that the tuple data is put together by the attribute data into a storage apparatus; and

data processing means for executing a predetermined process on the database,

wherein the data managing means stores attribute data constructing the tuple data into a plurality of chunks each having a storage region of a predetermined capacity set for each of the attribute data in order that the tuple data is positioned in the tabular form, obtains, by the attributes, deletion data information expressing information specifying the order in the tabular form of the tuple data including the attribute data deleted from the chunk set by the attributes by the data processing means, and releases the chunk on the basis of the deletion data information.

### Supplemental Note 9

An information processing method including the steps of, in an information processing apparatus,

at the time of storing data in a tabular form in which a group of tuple data made by a plurality of pieces of attribute data is positioned in a row direction and the attributes are positioned in a column direction so that the tuple data is put together by the attribute data into a storage apparatus, storing attribute data constructing the tuple data into a plurality of chunks each having a storage region of a predetermined capacity set for each of the attribute data in order that the tuple data is positioned in the tabular form,

obtaining, by the attributes, deletion data information expressing information specifying the order in the tabular form of the tuple data including the attribute data deleted from the chunk set by the attributes by the data processing means, and releasing the chunk on the basis of the deletion data information.

### Supplemental Note 10

The information processing method described in the supplemental note 9,

in the case where the attribute data is deleted from the chunk, the deletion data information specifying the order in the tabular form of the tuple data including the attribute data is stored by the attributes into the storage apparatus, the deletion data information is obtained by the attributes stored, and the chunk is released on the basis of the deletion data information.

A program described in the foregoing exemplary embodiments and the supplemental notes is stored in a storage apparatus or recorded in a computer-readable recording medium. For example, a recording medium is a medium having portability such as a flexible disk, an optical disk, an optical magnetic disk, or a semiconductor memory.

Although the present invention has been descried with reference to the exemplary embodiments, the invention is not limited to the above-described exemplary embodiments. Various changes which can be understood by a person skilled in the art can be performed on the configuration and the details of the present invention within the scope of the invention.

The present invention enjoys benefit of the claims of priority based on the patent application No. 2012-226238 filed on Oct. 11, 2012 in Japan and it is assumed that all of the content described in the patent application is included the specification.

### REFERENCE SIGNS LIST

1 information processing apparatus
11 processing unit
12 storage unit
21 column data
22 chunk list
23 offset management table
41 query processing unit
42 column data managing unit
43 chunk deletion determining unit
44 offset adjusting unit
45 table updating unit
101 information processing apparatus
122 chunk list
201 information processing apparatus
211 processing unit
244 common chunk releasing unit

What is claimed is:

1. An information processing apparatus comprising:
a data managing unit configured to store data in a tabular form, in which a group of tuple data including a plurality of pieces of attribute data is positioned in a row direction and the attributes are positioned in a column direction, into a storage apparatus, by putting together the tuple data for the each attribute data; and
a data processing unit configured to execute a predetermined process on a database,
wherein the data managing unit
stores attribute data constituting the tuple data, into a plurality of chunks each having a storage region of a predetermined capacity which is set for each of the attribute data, in order that the tuple data is positioned in the tabular form,
obtains, for the each attribute, deletion data information expressing information specifying the order in the tabular form of the tuple data including the attribute data deleted from the chunk which is set for the each attribute, by the data processing means,
and releases the chunk on the basis of the deletion data information.

2. The information processing apparatus according to claim 1, wherein when the attribute data is deleted from the chunk by the data processing unit, the data managing unit
stores the deletion data information specifying the order in the tabular form of the tuple data including the attribute data into the storage apparatus for the each attribute,
obtains the deletion data information stored for the each attribute,
and releases the chunk on the basis of the deletion data information.

3. The information processing apparatus according to claim 1, wherein when all of the attribute data stored in a predetermined chunk is deleted, the data managing unit stores the deletion data information specifying the order in the tabular form of the tuple data including the attribute data deleted from the chunk, for the each attribute, into the storage apparatus, and releases the chunk.

4. The information processing apparatus according to claim 1,
wherein when common deletion data information is included in each of the deletion data information obtained for the each attribute, the data managing unit deletes the common deletion data information, thereby advancing the order in the tabular form of the attribute data in the chunk storing the attribute data after the released chunk which corresponds to the common deletion data information deleted.

5. The information processing apparatus according to claim 1,
wherein the data managing unit obtains, as the deletion data information obtained for the each attributes, start data information specifying the order in the tabular form of the attribute data stored at the head of the chunk, and a number of pieces of attribute data which is the number of pieces of the attribute data stored in the chunk, and
in the case where the start data information and the number of pieces of attribute data which is common is included in each of the deletion data information for the each attribute, by deleting the start data information and the number of pieces of attribute data which is common, advances the order in the tabular form of the attribute data in the chunk storing the attribute data after the released chunk which corresponds to the common deletion data information, by the number of pieces of the attribute data.

6. The information processing apparatus according to claim 1, wherein the data managing unit obtains, from each of the chunks for the each attribute, start data information specifying the order in the tabular form of the attribute data stored at the head of the chunk and end data information specifying the order in the tabular form of the attribute data stored at the end of the chunk,
in the case where the start data information and the end data information is not continuous, obtains, as the deletion data information, information specifying the order in the tabular form of the attribute data in a discontinuous range and,
in the case where common start data information and common end data information is included in each of the deletion data information by the attributes, deletes the common start data information and the common end data information and advances the start data information and the end data information for the each attributes, thereby advancing the order in the tabular form of the attribute data in the chunk storing the attribute data after the released chunk.

7. The information processing apparatus according to claim 1, wherein in the case where the common deletion data information is included in each of the deletion data information obtained for the each attribute and the common deletion data information expresses that all of the attribute data stored in a predetermined chunk is deleted, the data managing unit releases the chunk corresponding to the common deletion data information and advances the order in the tabular form of the attribute data in the chunk storing the attribute data after the released chunk.

8. A non-transitory computer readable medium recorded with a computer program, for an information processing apparatus, that causes the information processing apparatus to function as:
a data managing unit configured to store data in a tabular form in which a group of tuple data including a plurality of pieces of attribute data is positioned in a row direction and the attributes are positioned in a column direction, into a storage apparatus, by putting together the tuple data for the each attribute data; and
a data processing unit configured to execute a predetermined process on a database,
wherein the data managing unit
stores attribute data constituting the tuple data, into a plurality of chunks each having a storage region of a predetermined capacity which is set for each of the attribute data in order that the tuple data is positioned in the tabular form,
obtains, for the each attribute, deletion data information expressing information specifying the order in the tabular form of the tuple data including the attribute data deleted, from the chunk which is set for the each attribute, by the data processing means,
and releases the chunk on the basis of the deletion data information.

9. An information processing method, performed by an information processing apparatus, comprising the steps of:
when storing data in a tabular form in which a group of tuple data including a plurality of pieces of attribute data is positioned in a row direction and the attributes are positioned in a column direction, into a storage apparatus, by putting together the tuple data for the each attribute data, storing attribute data constituting the tuple data into a plurality of chunks each having a storage region of a predetermined capacity which is set for each of the attribute data, in order that the tuple data is positioned in the tabular form; and
obtaining, for the each attribute, deletion data information expressing information specifying the order in the tabular form of the tuple data including the attribute data deleted from the chunk which is set for each attribute, and releasing the chunk on the basis of the deletion data information.

10. The information processing method according to claim 9, wherein in the case where the attribute data is deleted from the chunk,
storing the deletion data information specifying the order in the tabular form of the tuple data including the attribute data, for each attribute, into the storage apparatus,
releasing the chunk on the basis of the deletion data information by obtaining the deletion data information for each stored attributes.
